(19) United States
(12) Patent Application Publication
(10) Pub. No.: US 2002/0169805 A1
(43) Pub. Date: Nov. 14, 2002

(54) Web page color accuracy with image supervision

(75) Inventor: Christopher J. Edge, Saint Paul, MN (US)

Correspondence Address: Attention: William D. Bauer, Imation Corp., Legal Affairs, P.O. Box 64898, St. Paul, MN, 55164-0898, US

(73) Assignee: Imation Corp.

(21) Appl. No.: 09/808,849

(22) Filed: Mar. 15, 2001

(51) Int. Cl. G06K 9/00; G06F 15/00; G06F 17/00; G06F 17/21; G06F 17/24

(52) U.S. Cl. 707/528; 382/167

(57) ABSTRACT

Improved color image display accuracy can be achieved across a computer network by obtaining information characterizing the color response of display devices associated with a client residing on the computer network, and using the information to modify color images delivered to the client. Further improvements can be obtained by supervision of images during the upload process. In particular, in a system in which color-corrected images are provided from a web server to clients residing on a network, the invention promotes greater accuracy in the original images by monitoring and auditing the preparation of input images by color technicians. In one embodiment, a technician responsible for adjustment for each image is identified, and an upload is permitted if the technician satisfies a color adjustment skill criterion.

### TECHNICAL FIELD

The invention relates to color imaging and, more particularly, to presentation of color images on display devices.

### BACKGROUND

The growth of the Internet has created sizable opportunities for online retailers. Most major retailers of consumer products have established commercial sites on the World Wide Web. At the same time, the availability of web site presence has eliminated many of the marketing barriers previously experienced by smaller retailers. Virtually any retailer can now post product information for easy access by potential customers, and take orders for its products in an automated fashion.

The product information may include a large number of images. The images enable web customers situated at client devices to view products before submitting an online purchase order. For some items, the user is permitted to click on a “thumbnail” image to view the item in a higher resolution format. In many cases, however, the quality of the images can be a significant concern. Color accuracy, in particular, can be very important for products for which color is a major selling point.

In the case of clothing retailers, for example, an image of a sweater should match its actual color as closely as possible. Unfortunately, the color output characteristics of different display devices can differ significantly. A cathode ray tube (CRT) or flat panel display, video card, driver software, and operating system together determine how red, green, and blue (RGB) pixel values will be rendered and displayed, and vary significantly from system to system.

Consequently, an online customer may order what appears to be a burgundy sweater but instead receive a bright red sweater. Indeed, color inaccuracy has become a significant cause for return of merchandise purchased by online customers. In some cases, this problem can erase the advantages obtained by a seller's commitment to online merchandising, and undermine continued investment.

### SUMMARY

The invention is directed to improved color image display accuracy in a computer network having display devices with different color output characteristics. The invention improves color accuracy in web pages by controlling accuracy at both the input and output side of an image transfer process in which the image is uploaded to a server and downloaded to a client for display. For example, in a system in which color-corrected images are provided from a web server to clients residing on a network, the invention promotes greater accuracy in the original images uploaded to the web server.

Colorimetric differences among the display devices used by the clients at the output side that download images are only part of the color accuracy problem. If the original images are not carefully prepared and managed during the upload process, they can negate the advantages of color corrections made for the display devices. In other words, lack of color quality during the upload process can result in a “garbage in-garbage out” situation. In this case, color inaccuracy in the input data can overwhelm subsequent efforts to correct the output data for display clients.

As an example, consider the case in which a technician acquires an image of a retail item, such as a red sweater, using a digital camera. If the technician does not carefully proof and adjust the image relative to the actual item, the color accuracy of the image is subject to the colorimetric characteristics of the camera, which can vary widely.

In this case, color adjustments made to the image to compensate for the color response characteristics of a particular display device may be futile. In particular, the color of the original image may be so inaccurate as to make color matching with the original item virtually impossible. Thus, color accuracy can be strongly influenced by the skill and care of the technician responsible for preparing the input image.

In one embodiment, the invention provides a method comprising identifying a technician responsible for adjustment of color characteristics of an image, and permitting an upload of the image to a web server if the technician satisfies a qualification criterion.

In another embodiment, the invention provides a computer-readable medium containing instructions that cause a programmable processor to identify a technician responsible for adjustment of color characteristics of an image, and permit an upload of the image to a web server if the technician satisfies a color adjustment skill criterion.

The details of one or more embodiments of the present invention are set forth in the accompanying drawings and the description below. Other features, objects, and advantages of the present invention will be apparent from the description and drawings, and from the claims.

### BRIEF DESCRIPTION OF THE DRAWINGS

FIG. 1 is a block diagram of a system for serving color-customized web pages;

FIG. 2 is a block diagram of a web-based environment incorporating a system as shown in FIG. 1;

FIG. 3 is a block diagram of a system for supervising and auditing the quality of input images submitted for color correction;

FIG. 4 is a flow diagram illustrating a process for supervising addition of input images based on technician skill criteria;

FIG. 5 is a flow diagram illustrating a color profiling process for a display device associated with a network client;

FIG. 6 is a block diagram illustrating a system for serving color-customized web pages in greater detail; and

FIG. 7 is a block diagram illustrating adjustment of color images for a network client.

FIG. 8 is a flow diagram illustrating a multi-channel black point determination in a color profiling process;

FIG. 9 is a diagram of a web page for analog adjustment of a color display prior to black point determination;

FIG. 10 is a diagram of a web page for determination of black point for a particular color channel;

FIG. 11 is a flow diagram illustrating gamma and gray balance determination in a color profiling process;

FIG. 12 illustrates a range of gray elements for use in determining a coarse gamma in a color profiling process;

FIG. 13 illustrates a range of gray elements for use in determining a fine gamma in a color profiling process;

FIG. 14 illustrates a range of gray elements for use in determining gray balance in a color profiling process; and

FIG. 15 is a block diagram illustrating transmission of color correction information in a system as shown in FIGS. 1 and 2.

### DETAILED DESCRIPTION

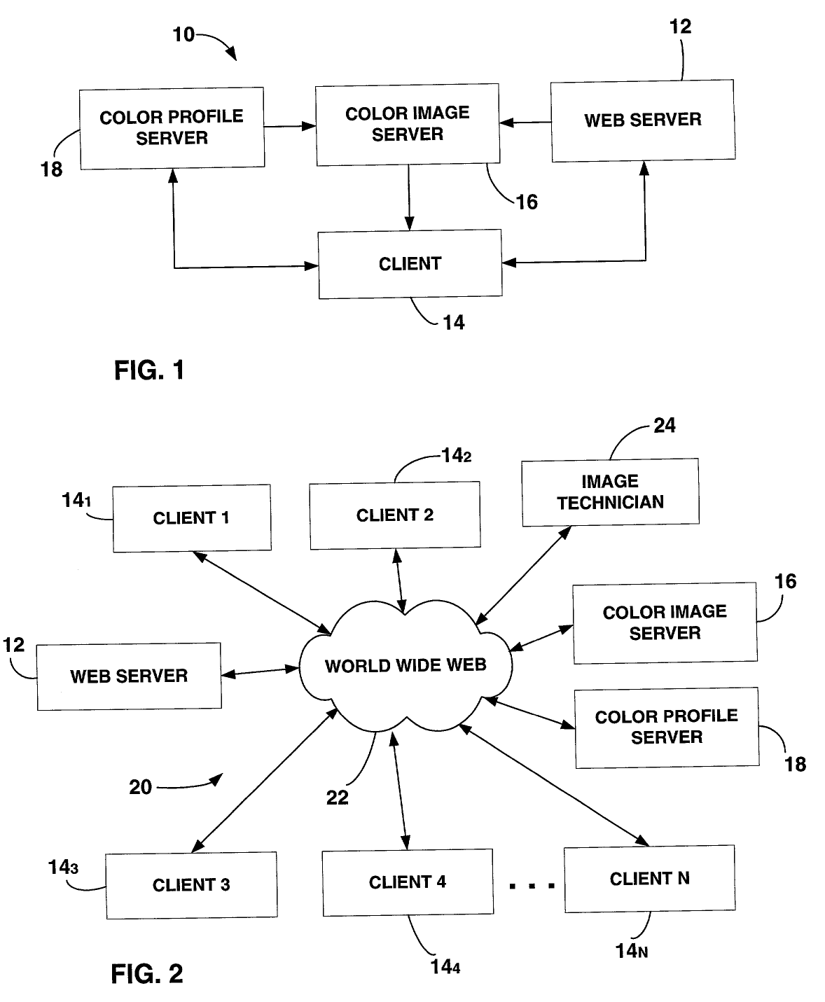

FIG. 1 is a block diagram of a system 10 for improving color image display accuracy across a computer network. The computer network may take the form of a local area network, wide area network, or global computer network such as the World Wide Web. As shown in FIG. 1, system 10 may include a web server 12, a network client 14, a color image server 16, and a color profile server 18. Servers 12, 16, 18 may be integrated and managed as a common network domain, or provided as independent servers that communicate over the network.

Web server 12 communicates web pages to client 14 upon request. The web pages may include tagged images stored either at web server 12 or color image server 16. In one embodiment, a color correction module adjusts the images based on color response characteristics of a display device associated with client 14. For color-customization of the tagged images, the color correction module may access color profiles or other similar information that is stored in a database or uploaded from client 14. The color correction module may reside at color image server 16, web server 12, or elsewhere within system 10.

Web server 12 may store lower resolution color images as well as images that are less color-intensive. Higher resolution color images and more color-intensive images can be stored at color image server 16. Client 14 may be one of many clients who download color images from web server 12, color image server 16, or both. There are potentially a large number of clients 14 downloading web pages from web server 12, along with tagged images from color image server 16. For example, clients 14 may be retail customers accessing web pages with tagged images representing retail items such as clothing, artwork, and the like.

Unfortunately, the display devices used by clients 14 may vary widely in colorimetric response. A color image that appears satisfactory when displayed on the display device of one client 14 may appear less than satisfactory when displayed on any of the display devices associated with other clients. The color characteristics of a cathode ray tube (CRT) or flat panel display, video card, driver software, and operating system can vary significantly from client to client. Adjusting the color images according to the colorimetric response characteristics of individual clients 14 can compensate for the differences.

Compounding the color accuracy problem are inaccuracies that can be introduced in the process of preparing the images for upload to web server 12 or color image server 16. Original images obtained from a camera or other acquisition device often ordinarily will require careful preparation by a color image technician to ensure the images accurately depict the items they represent. If a technician lacks sufficient skill or care, however, the input images can introduce inaccuracies that overwhelm attempts to correct color for a particular network client 14.

In one embodiment, the invention provides a method that promotes greater accuracy in the original images uploaded to the web server. The method involves adjusting color characteristics of an image, and identifying the technician responsible for the adjustment. If the technician satisfies a color adjustment skill criterion, the method permits an upload of the image to the web server. If not, the upload is denied. In this manner, the invention adds accountability and control to the process, requiring that only appropriately skilled technicians and technicians that exercise due care be qualified to handle image preparation.

The color adjustment skill criterion may be part of a set of skill criteria. The criteria may be based in part on the result of an objective color skill test administered to the technician, as well as periodic audits of images submitted by the technician. The skill test determines whether the color technician possesses the basic skills necessary to adjust input images and provide color accuracy relative to items represented by the images. The audit determines whether a color technician having the necessary skill nevertheless exercises them with due care. Thus, the skill criteria are useful in identifying those technicians who are not adequately trained or who may be careless in image preparation.

To assess technician skill, an objective skill test can be administered. For example, the test can be given by a domain administrator or an independent organization or entity known to be highly skilled in the field of color imaging. The test may involve a number of color adjustment tasks, such as adjustment of a series of different images, followed by assessment of calorimetric characteristics of the images relative to target images. If the technician produces a result within an acceptable error margin, the technician passes the test. Based on successful results of the test, the technician may be awarded a certification that is recorded in a qualification database. In some embodiments, the certification may permit the technician to perform image preparation work for several different web domains.

If a technician satisfies the skill criteria, there is a greater chance that the color customization performed for each client 14 will have a significant effect on color accuracy. In particular, there is a greater chance that the input images submitted by technicians for color customization will have increased color accuracy. To obtain the necessary colorimetric response information for a client 14, the invention may involve a color profiling process. The color profiling process will now be described.

With further reference to FIG. 1, color profile server 18 may administer the color profiling process for client 14. Once the color profiling process is complete, color profile server 18 generates information characterizing the colorimetric response of the display device associated with client 14. The information for client 14 can be transmitted to color image server 16 by color profile server 18. In one embodiment, the information for client 14 is stored in a color profiling cookie that is downloaded to the respective client.

Client 14 initially interacts with web server 12 to access a web page. On the first attempt to access a web page, client 14 may be redirected to color profile server 18 to complete the color profiling process for acquisition of calorimetric response information. In particular, the web page served by web server 12 may include a reference to one or more tagged images stored on color image server 16.

When color image server 16 receives a request for the tagged images, it first determines whether the requesting client 14 has a color profile. In one embodiment, color image server 16 detects whether client 14 has uploaded a color profile cookie. If so, it generally is not necessary to repeat the color profiling process for client 14. Rather, the calorimetric response information required by color image server 16 is stored in the cookie.

The cookie may contain, for example, parametric information characterizing the colorimetric response of display device associated with client 14. Color image server 16 extracts the contents of the cookie and prepares a color profile for client 14. Alternatively, color profile server 18 may precompute a color profile based on the results of a color profiling process and then add the profile to the cookie. The parametric information or precomputed color profile may include information pertaining to the estimated blackpoint, gamma, and gray balance of a display device associated with client 14.

If color image server 16 does not detect a color profile cookie from client 14, the client is redirected to color profile server 18. Color profile server 18 then completes the color profiling process. The color profiling process may involve communication of one or more web pages from color profile server 18 to client 14. The web page can be designed to guide the user associated with client 14 through a series of steps for input of color response information such as blackpoint, gamma, and gray balance.

Color image server 16 extracts the calorimetric response information from the color profile cookie. Color image server 16 then retrieves one or more images requested by user 14. Using the color profile for client 14, color image server 16 set the color values in a requested image. In particular, color image server 16 may apply color transformations, or other modifications, to the image to adjust the color values in the image based on the color response of the display device associated with client 14. Color image server 16 then communicates the color-modified image to client 14. In this manner, the color of the image displayed by client 14 more accurately matches the color of the image as originally intended.

Web server 12, client 14, color image server 16, and color profile server 18 each execute program code stored on computer-readable media residing either locally with the respective device or executed remotely. For client 14, for example, the program code may reside in random access memory (RAM) that is accessed and executed by the client computer. The program code can be loaded into the memory from another memory device, such as a fixed hard drive or removable media device associated with client 14.

The program code can be initially carried on computer-readable media, for example, such as magnetic, optical, magneto-optic or other disk or tape media, or electronic media such as EEPROM. Alternatively, the program code can be loaded into the medium by transmission from a remote data archive, e.g., via a local area network, wide area network, or global network such as the Internet. A substantial portion of the code may be web page code that is transmitted to the respective device and executed by a server or browser application.

Web page code, e.g., Hypertext Markup Language (HTML), Extensible Markup Language (XML), or the like, generated by web server 12 may include image tags that point to specific color images stored at color image server 16 or elsewhere. When client 14 accesses a particular web page delivered by web server 12 and executes the HTML to assemble the page content, color image server 16 is accessed to obtain any images tagged within the web page code. Thus, the content of a web page assembled for client 14 may include images and other objects obtained from different resources within the network occupied by system 10, such as web server 12 and color image server 16.

In some embodiments, web server 12 and color image server 16 may be integrated with one another. In the example of FIG. 1, however, color image server 16 and web server 12 are separate entities. Web server 12 and color image server 16 each may interact with a common database server and file server to obtain access to selected color images for delivery to client 14. Moreover, in operation, web server 12 may be realized by one of several web servers that access one or more common file and database servers.

Client 14 may take the form of a variety of devices that permit a user to access resources on system 10 and display color images obtained from such resources. Examples of client 14 include desktop or portable computers operating in a Windows, Macintosh, Unix, or Linux environment, personal digital assistants (PDA's), based on the Palm, Windows CE, or similar operating system environments for small portable devices, Internet-equipped wireless telephones, interactive televisions with set-top boxes for Internet access, Internet kiosks available to the general public, and future Internet appliances that may emerge.

Client 14 preferably executes a graphical viewing application such as a web browser to access resources residing on other resources, such as web server 12 and color image server 16, attached to system 10. A web browser application permits the user associated with client 14 to readily view web pages generated by web server 12, and images served by color image server 16. Other user interface applications may be useful in accessing web server 12 provided the information is presented in a user-interactive format.

In some embodiments, color image server 16 may be configured to deliver color corrected video imagery, in addition to static images. Video, such as MPEG clips, streaming video, and the like may suffer from similar color accuracy issues if they are not compensated for the effects of the display device associated with an individual client 14. Thus, some embodiments of the invention may be particularly useful for broadcast-like video content.

In each case, clients 14 include a display device, such as a cathode ray tube or flat panel display, for display of color images obtained from web server 12 and color image server 16. Other types of displays as well as dynamic viewing media such as electronic paper are contemplated. Communication between web server 12, client 14, and color image server 16 may take place using conventional network protocols such as TCP/IP.

Although some of the client devices described above, such as PDA's and wireless telephones, presently incorporate relatively low quality color displays, it is anticipated that such devices will benefit from higher quality color displays in the near future. Accordingly, system 10 will be readily applicable in enhancing the quality of color images displayed by PDA's, wireless telephones, and similar devices in the future.

The color profiling process, and hence improved color accuracy, may be optional, for client 14. For some items, color accuracy may not be significant. When client 14 accesses a web page from web server 12, the user may be given a choice between viewing a version of the web page with default color settings, which may be less accurate, or viewing a more accurate web page with images formulated based on the results of the color profiling process. Thus, color image server 16 may store a set of default images to be used in the event the user does not elect the color profiling option.

A web page initially delivered to client 14 by color image server 16 may be embedded in a web page with one or more hypertext links for initiation of the color profiling process. The web page and the links may be served to client 14 in the event the color profiling process was not previously completed. Upon selecting an appropriate link, client 14 interacts with color profile server 18 to perform the color profiling process.

If the link is not selected, client 14 simply views the default web page image without the benefit of color correction by color image server 16. With the web page, client 14 also may view an indication of whether color profiling and correction have been applied. The indication may take the form of an icon that changes color to indicate when color profiling has been activated.

When the user clicks on the hypertext link to start the color profiling process, client 14 accesses color profile server 18 for delivery of a series of instructional web pages to the user. The web pages delivered by color profile server 18 guide the user through a number of steps designed to estimate the colorimetric response characteristics of the particular display device associated with client 14.

When the process is complete, color profile server 18 delivers a web page with content that, when executed, generates a cookie containing the color profile information. The cookie then can be uploaded to color image server 16 for use in modifying the color images for a web page to produce higher quality color output on the display device associated with client 14.

Other techniques for obtaining the color profiling information may not require direct interaction by the user with color image server 16. Instead, the user may voluntarily visit a web site to perform color profiling. The web site may be provided by color profile server 18 or be within the same domain as the color profile server. Alternatively, a user may profile the display device associated with its individual client 14 by executing software downloaded or physically delivered to them.

FIG. 2 is a block diagram of a web environment 20 incorporating a system as shown in FIG. 1. In the example of FIG. 2, web environment includes web server 12, which serves web pages via World Wide Web 22. Web environment 21 includes a number of clients 14₁-14_{N}. Color image server 16 serves images referenced by the web pages delivered by web server 12. Color profile server 18 guides the color profiling process by serving web pages to clients 14₁-14_{N} over World Wide Web 22. A color image technician 24 prepares the images for upload to color image server 16.

Color profile server 18 then transmits the colorimetric information obtained from clients 14₁-14_{N}, as color profiles or parametric information, to color image server 16 via World Wide Web 22. Color image server 16 then sends to clients 14₁-14_{N} web pages that, when executed, generate cookies containing the information. In this manner, the colorimetric information can be used in future downloads of web pages and color images.

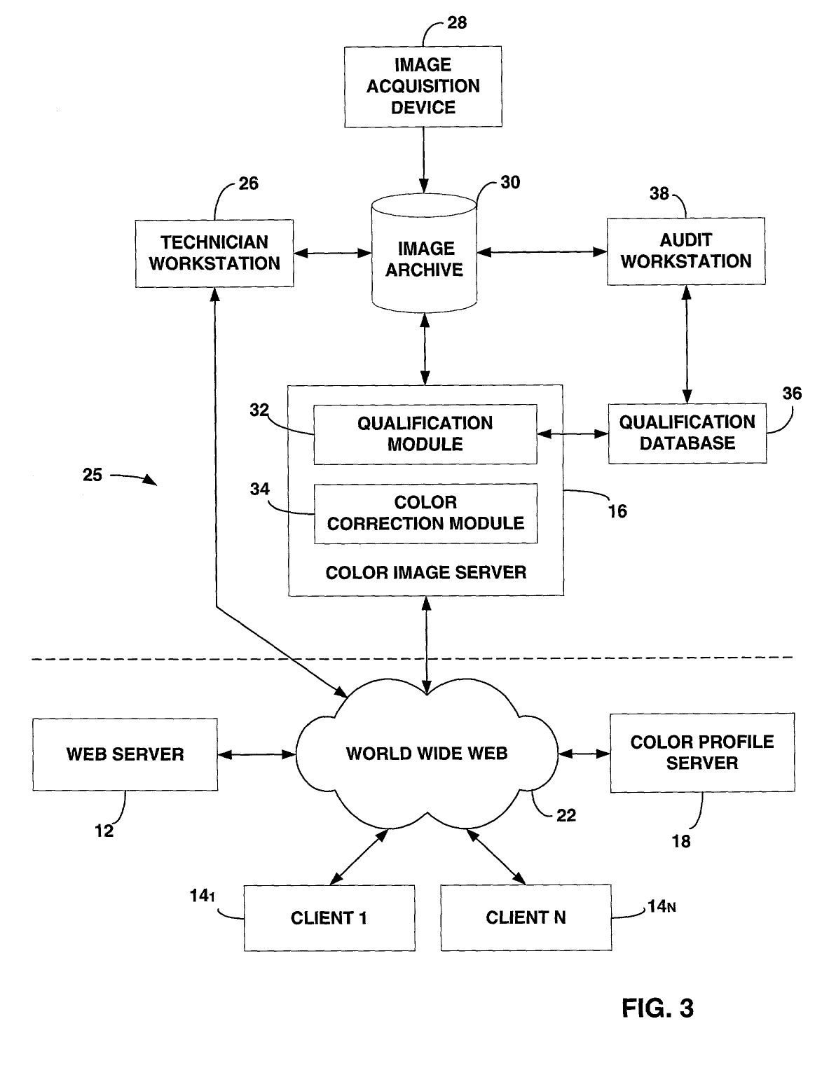

FIG. 3 is a block diagram of a system 25 for supervising and auditing the quality of input images submitted for color correction. As shown in FIG. 3, system 25 may reside behind a firewall with color image server 16. System 25 may include a technician workstation 26, an image acquisition device 28, an image archive 30, a qualification module 32, a color correction module 34, a qualification database 36, and an audit workstation 38.

Technician workstation 26 may be a computer equipped with commercially available graphic arts editing software and a display device with stable, calibrated color output. A technician uses technician workstation 26 to adjust images uploaded to image archive 30 so that the images more accurately represent the items they depict. Image acquisition device 28 may be a camera or other image input device and is an optional part of system 25. As an alternative, images can be obtained from image acquisition devices that do not form part of system 25. Instead, images obtained from the image acquisition devices can be communicated to system 25 electronically via web 22 or on removable data storage media.

Image archive 30 may include a file and database server and store images adjusted by technician workstation 26 and accessed by color image server 16. The images may correspond to images tagged within web pages generated by web server 12. Images can be stored in different stages within image archive 30. For example, images can be stored in unedited, edit-in-progress, and final stages. For final stage images, the image preparation process is finished by technician workstation 26. Unedited images have not been processed by technician workstation 26 yet, while edit-in-progress images are stored in varying states of editing. Color image server 16 access final stage images after they have been associated with a particular tagged image in one of the web pages generated by web server 12.

Qualification database 36 may store a list of color image technicians and their qualification levels. The qualification levels may include indications of the levels of skill and care possessed by a technician. Skill levels can be determined by objective tests, whereas care levels can be determined by a combination of objective tests and auditing of images actually prepared by the technicians. Thus, each technician operating within system 25 may have a corresponding profile in qualification database 36, with an indication of pertinent skill and care levels.

Qualification module 32 may be a software process running on color image server 16 or a different computer within system 25. Qualification module 32 analyzes images in image archive 30 to determine whether they were prepared by authorized technicians. In one embodiment, each image file in image archive 30 may include a header or a pointer to another file that identifies the particular technician that prepared the image. The identification may be an encrypted or non-encrypted identity code assigned to the technician. In other embodiments, the image files may remain unchanged with the identification being provided in metadata for the image file in a database maintained by the system. In this case, the identification may be stored external to the image file, eliminating the need to modify the contents of the image file.

Using the technician identification associated with the image, qualification module 32 accesses a qualification profile from qualification database 36. Based on the qualification profile, qualification module 32 determines whether the technician who prepared the image has the requisite skill and care levels. If so, qualification module 32 approves the image for delivery to color correction module 34. In this case, color correction module 34 may perform a color correction on the image based on the colorimetric response characteristics of a particular client 14. The actual color correction may take place at a later time.

If the technician does not have the requisite skill and care levels, qualification module 32 disapproves the image for delivery to color correction module 34. In this case, rather than attempt to correct an inaccurate image, color image server 16 serves the image to client 14 with an indication that color correction is not presently available for the image. In this manner, supervision of the images uploaded to color image server 16 instills confidence in the color correction process. Serving a default image ordinarily will be better than serving a color-corrected, but still inaccurate, output image based on erroneous input data. This avoids the appearance that the color correction process does not work properly.

Instead of evaluating each image as it is requested by a client 14, qualification module 32 may be configured to qualify a batch of images. If the images pass the qualification process, i.e., the technicians who prepared the images meet the skill and care levels, they can be flagged or set aside in a particular folder. In this manner, qualified images can be distinguished from unqualified images when color image server 16 retrieves them from image archive 30.

Audit workstation 38 can be provided to review images prepared by a technician. In particular, audit workstation 38 may take the form of a computer equipped with commercially available graphic arts viewing software and a calibrated, stable display device. Audit workstation 38 also may include precision color measurement equipment such as a colorimeter, densitometer, or spectrophotometer. A highly skilled technician may use audit workstation 38 to evaluate the color values of images retrieved from image archive relative to the colors of the items they depict.

Using audit workstation 38, the technician may determine whether the color of an image is within a predetermined error margin of a target color for the depicted item. In some embodiments, audit workstation 38 retrieves a set of images for a particular technician, either at random or according to some criteria such as date of submission or image type. In this manner, audit workstation 38 samples images submitted by a particular technician.

If the error margin is not satisfied for a certain percentage of the images, audit workstation 38 can be configured to change the qualification profile for the technician in qualification database 36. As an example, audit workstation 38 may simply revise the profile to indicate that the technician is unqualified, or qualify the technician at one of several qualification levels. Thus, a technician having lesser skill or exercising lesser care may be qualified for preparation of less color-critical images. Qualification module 32 may access the technician qualification profiles in qualification database 36 “on-the-fly,” i.e., in response to a request for a particular image for a client 14. Alternatively, qualification module 32 may access the technician qualification profiles as part of a batch qualification of images submitted to image archive 30.

In the example of FIG. 3, technician workstation 26, audit workstation 38, and qualification database 36 are shown generally as part of a common domain residing behind a common firewall. In some embodiments, however, technicians may be responsible for preparing images for many different web servers 12 and color image server 16. In this case, it may be desirable to provide a more widely accessible, or even global, qualification database 36.

In particular, a central qualification database 36 or series of distributed, replicated qualification databases could be made accessible by qualification modules 32 and audit workstations running on many different color image servers situated across a network. In this case, the qualifications of technicians who are service providers to more than one color image server 16 could be tracked across the network. The identities of the technicians, embedded in the images or otherwise, could take the form of global identification codes that qualify the technicians, via qualification database 36, for image preparation of different levels of color complexity.

As a further alternative, the identification code itself may serve as evidence of a given skill and care level, making reference to a qualification database unnecessary. Instead, the identification codes could be issued and revoked according to the outcome of the quality and care evaluations performed by audit workstations 38. In this case, reference could be made to a central database to verify the validity of an identification code. Each identification code could be categorized or classed according to skill and care level, and carry an intrinsic clearance to perform certain levels of color image preparation.

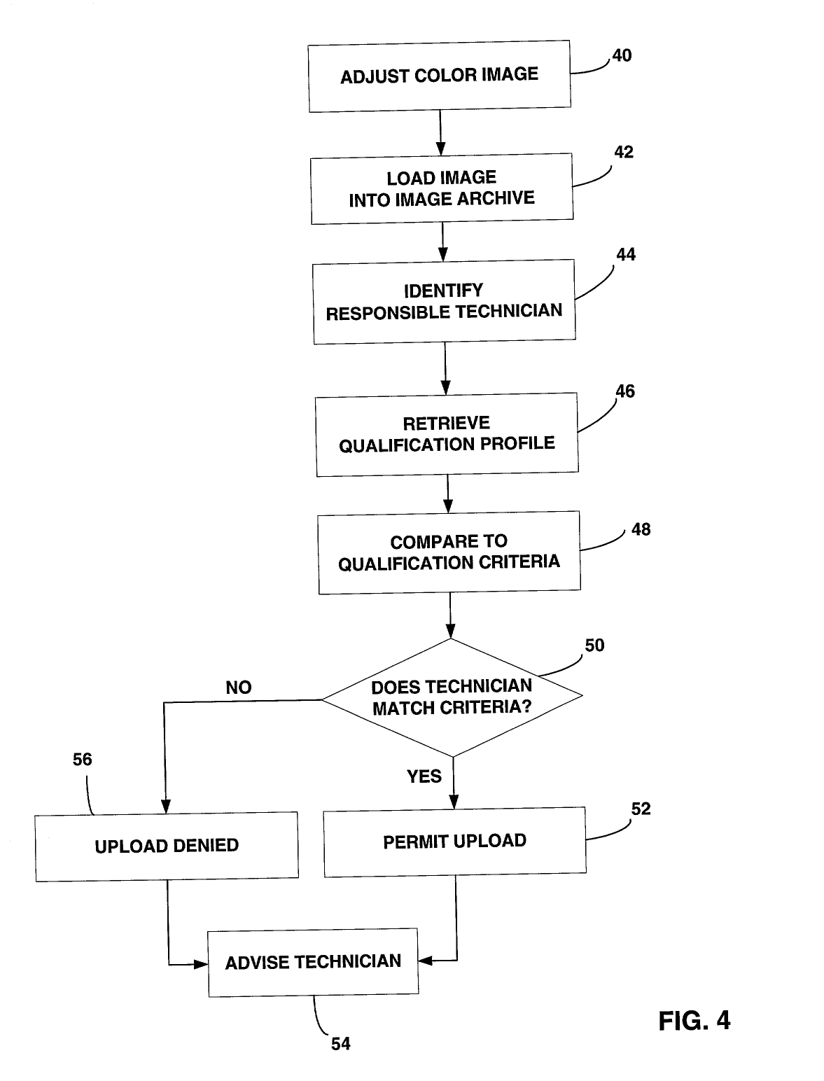

FIG. 4 is a flow diagram illustrating an example process for supervising addition of input images based on technician skill criteria. The example of FIG. 4 generally outlines the process from adjustment and submission of an image by the technician to the upload of the image to color image server 16 for color correction. Following adjustment of the color values in a color image (40) by a technician, the technician loads the adjusted image into image archive 30 (42).

After an image is loaded into image archive 30, qualification module 32 may then identify the technician responsible for adjusting and uploading the image (44). Once the technician is identified, the qualification module 32 retrieves a qualification profile (46) and compares the qualification profile to pertinent qualification criteria (48). Again, the qualification criteria may include minimum skill and care levels for preparation of a particular color image. If the qualification profile matches, i.e., meets or exceeds, the qualification criteria (50), qualification module 32 permits an upload of the image to color image server 16 (52). The technician may be advised to that effect (54). If the qualification profile does not match the criteria, qualification module 32 may deny the upload (56).

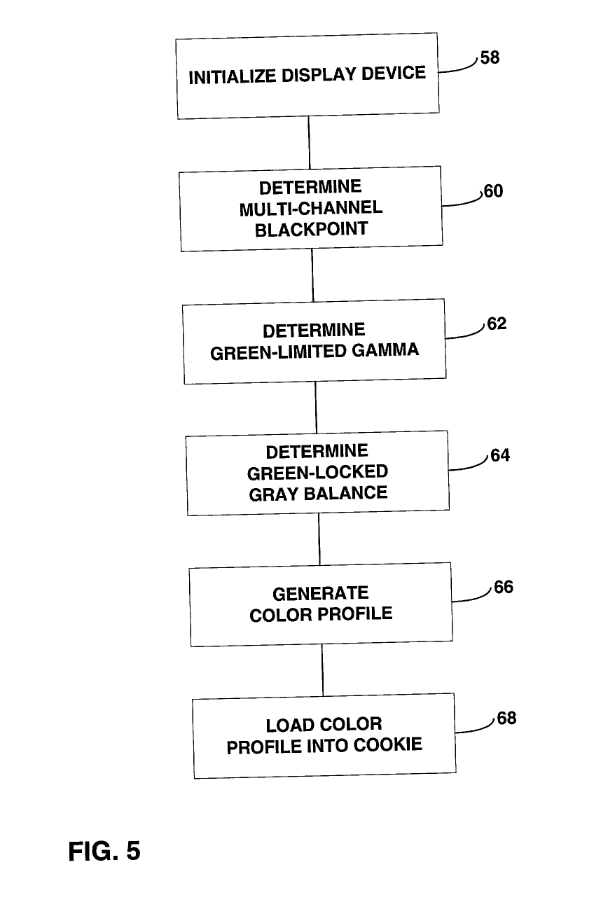

If a technician is known to possess a sufficient skill level and exercise sufficient care, images prepared by the technician are more likely to produce accurate results when color corrected for a particular client 14. FIG. 5 is a flow diagram illustrating a color profiling process for a client 14. As shown in FIG. 5, the color profiling process for client 14 may involve initialization of the display device to a standard setting (58). A blackpoint estimate for the display device is then determined (60), typically by user interaction. The blackpoint estimate may be a multi-channel blackpoint estimate. Upon determination of the blackpoint estimate, an estimate of the gamma for the display device is obtained, again typically by user interaction (62). The gamma may be limited to the green channel.

Next, a gray balance for the display device is determined (64). The gray balance estimate can be locked to the green channel in the sense that the green-limited gamma from the gamma estimate may be held constant while red-blue shifts are explored to determine gray balance. When the blackpoint, gamma, and gray balance have been estimated, color profile server 18 generates a color profile (66). The color profile contains information representing the blackpoint, gamma, and gray balance of the display device. The color profile, or parameters useful in forming the color profile, can be loaded into a web cookie (68). Client 14 stores the web cookie for uploading to color image server 16 when a subsequent image is requested.

To carry out a color profiling process as described with reference to FIG. 5, color profile server 18 delivers a series of web pages to client 14. Each of the web pages is designed to guide the user through a given step in the color profiling process. One web page, for example, may include instructions and image content designed to extract from the user an estimate of the blackpoint of the display device.

In one embodiment, the blackpoint estimate may be an estimate of multiple, channel-specific blackpoints. Other web pages may include instructions and content designed to extract coarse gamma, fine gamma, and gray balance information. In particular, each web page may include interactive media such as hypertext icons and the like that can be clicked upon by the user to transfer information from client 14 to color profile server 18. Upon collecting the necessary information, color profile server 18 creates the cookie and delivers it to client 14 for local storage and future use.

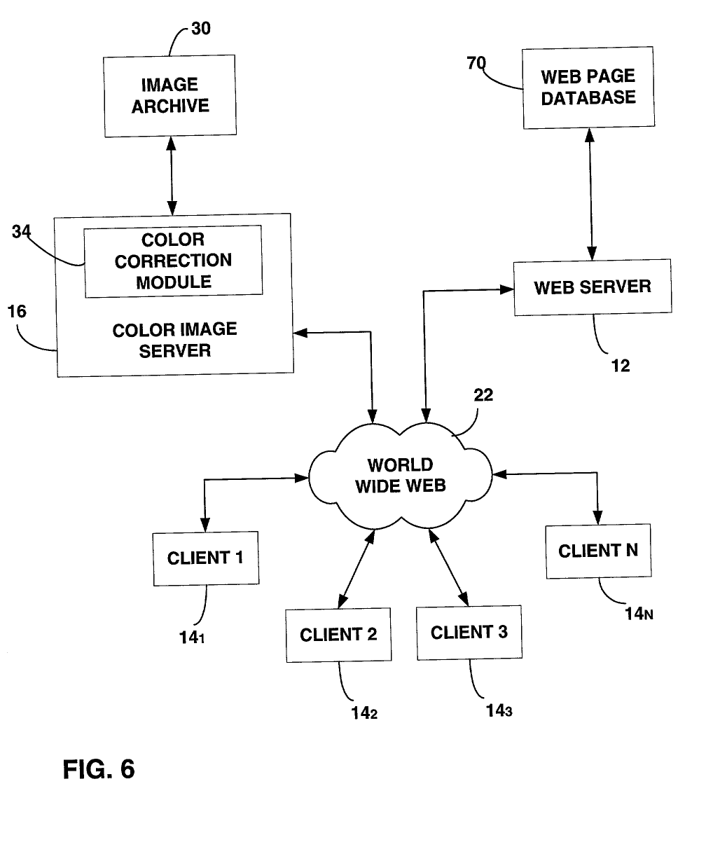

FIG. 6 is a block diagram illustrating a system for serving color-customized web pages in greater detail. As shown in FIG. 6, web server 12 accesses web page database 70 to communicate web pages to clients 14₁-14_{N} via web 22. In one embodiment, color image server 16 accesses image archive 30. Image archive 30 contains images referenced by the web pages served by web server 12. In the example of FIG. 6, color image server 16 also includes color correction module 34. Color correction module 34 responds to requests for color-corrected images from clients 14₁-14_{N}.

Color image server 16 retrieves the default color image from image archive 30 and, if client 14 has uploaded a color profile cookie, formulates a color-corrected image. In particular, color correction module 34 modifies the default image based on the color response characteristics indicated by the color profile cookies. Color correction module 34 sets the color values in the image to compensate for calorimetric response differences in the display device associated with client 14. As described with reference to FIG. 3, color correction module 34 may work in conjunction with qualification module 32 to correct only images prepared by qualified technicians. Alternatively, color correction module 34 may be configured to retrieve only qualified images from image archive 30.

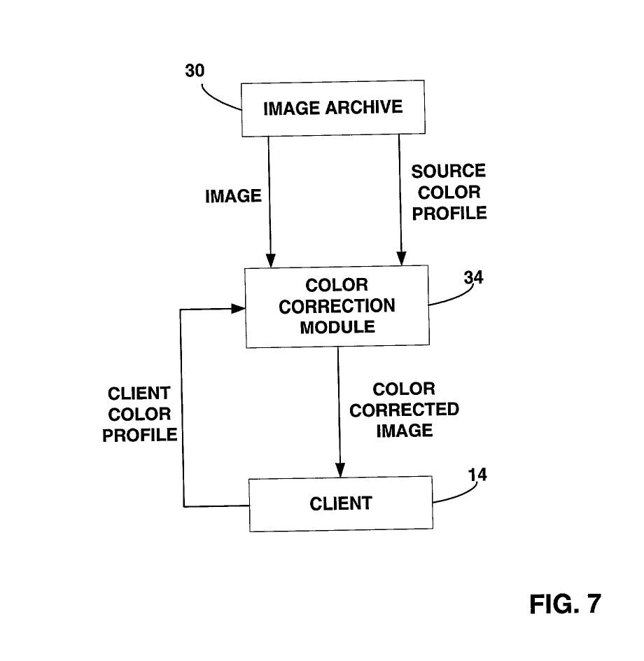

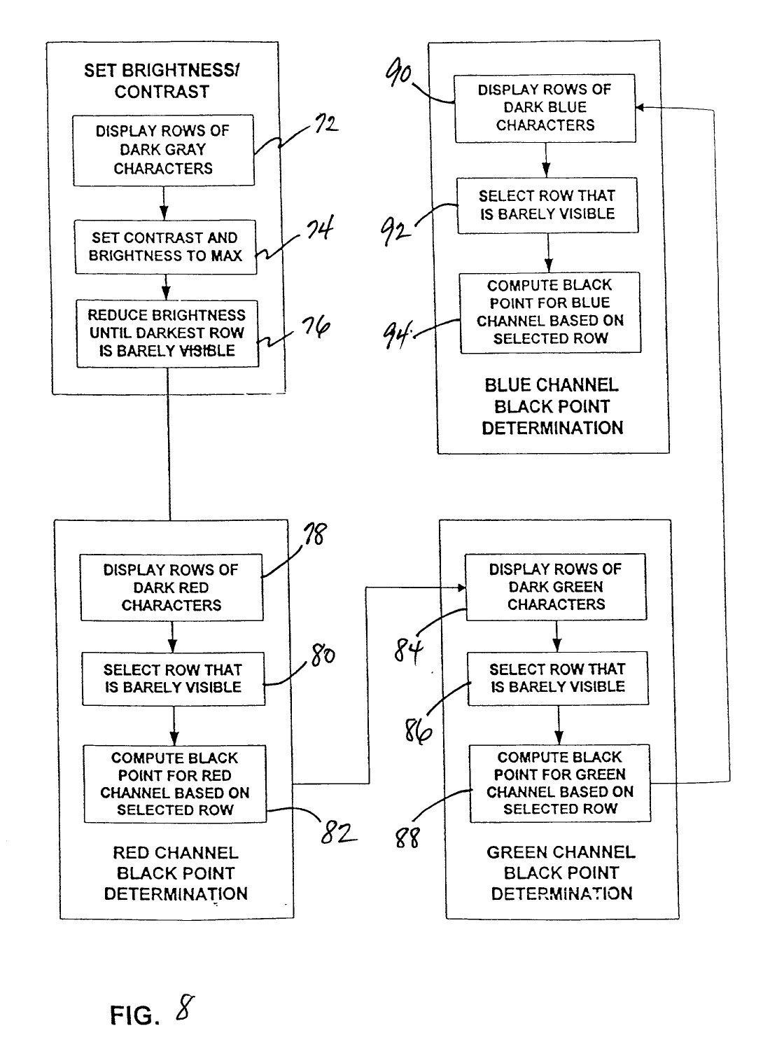

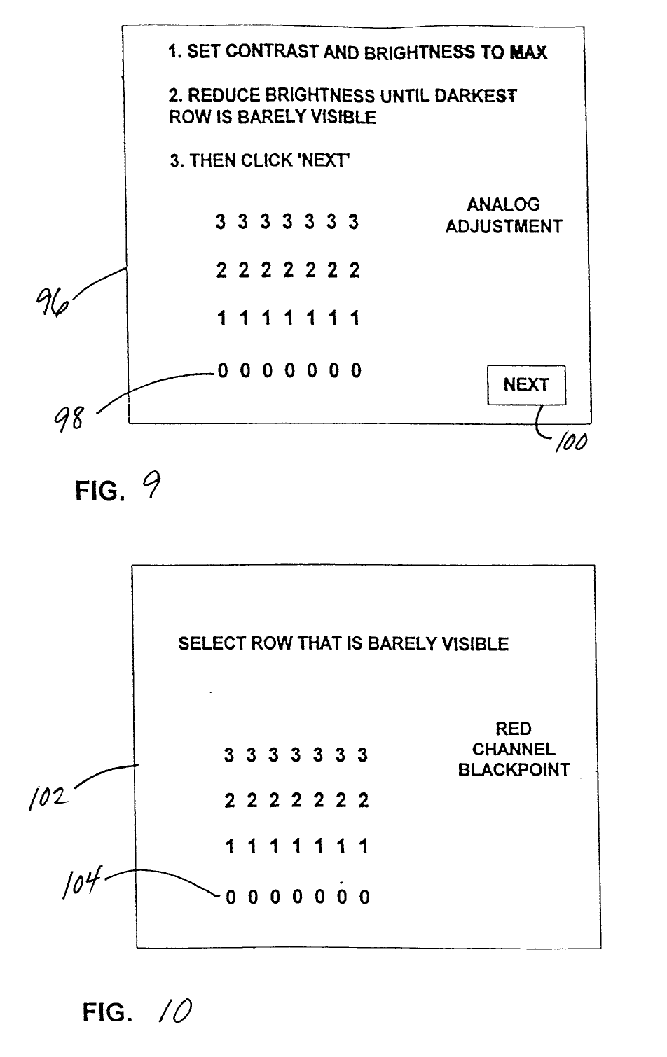

FIG. 7 is a block diagram illustrating adjustment of color images for a network client. As shown in FIG. 7, to facilitate color correction, each image prepared by a technician and stored in image archive 30 may be associated with a source color profile. The source color profile may be embedded in the image file or stored separately. The source color profile specifies a set of color response characteristics associated with the original image. Color correction module 34 receives the source color profile and a client, or “destination,” color profile from a client 14 via the network.

The client color profile represents the color response characteristics of the display device associated with client 14, and may be stored in a web cookie uploaded by client 14 with a request for a tagged image. Color correction module 34 uses the source color profile and client color profile to generate a color transformation that compensates for the color response differences between the source color profile and the client color profile. Using the color transformation, color correction module 34 generates a color corrected image and communicates it to client 14 via the network.

The source color profile and client color profile may be used in a manner substantially similar to the use of source and destination profiles in commercially available color management systems. Thus, part of the image preparation process carried out by a technician may include creation or modification of a source color profile for each image. The technician may create or modify a source color profile using commercially available graphic arts software tools. In some cases, the original image submitted to the technician for preparation may be accompanied by a source color profile generated by the image acquisition device.

An image supervision process as described herein is especially useful with color correction processes that produce color profiles for individual clients 14. Processes for color profiling of a display device associated with a client 14 and processes for management of cookies containing color profile information are described in detail in U.S. provisional application serial No. 60/193,725, filed Mar. 31, 2000, U.S. utility application Ser. No. 09/631,312, filed Aug. 3, 2000, and U.S. provisional application serial No. 60/246,890, filed Nov. 1, 2000. The content of each of the foregoing patent applications is incorporated herein by reference in its entirety.

In general, the color profiling process preferably requires no plug-ins, Java scripts, or other significant client-side processes. Instead, interaction between web server 12, client 14, color image server 16, and color profile server 18 is via web pages delivered to the clients. This approach yields significant convenience for the end user associated with client 14. At the same time, web server 12 and color image server 16 are not required to retain color information for individual users.

Rather, the information can be uploaded to color image server 16, e.g., in the form of a cookie, whenever color images are requested by a client 14. Moreover, site administrators can maintain their own color images at color image server 16, and provide color correction by incorporating a color correction module capable of handling the color profile cookies uploaded by individual client 14. Accordingly, there is no need for the site administrators to post their web pages or images to a central web repository.

To carry out a color profiling process, client 14 interacts with color profile server 18. Color profile server 18 delivers a series of web pages to a client 14. Each of the web pages is designed to guide the user through a given step in the color profiling process. One web page, for example, may include instructions and image content designed to extract from the user an estimate of the blackpoint of the display device.

In one embodiment, the blackpoint estimate may be an estimate of multiple, channel-specific blackpoints for the individual color channels of the display device. Other web pages may include instructions and content designed to extract coarse gamma, fine gamma, and gray balance information. In particular, each web page may include interactive media such as hypertext icons and the like that can be clicked upon by the user to transfer information from client 14 to color profile server 18.

Upon collecting the necessary information, color profile server 18 creates the cookie and delivers it to the client 14 for local storage and future use. In some embodiments, two cookies can be provided to client 14. A first cookie may correspond to a domain name associated with color profile server 18, and be used for future interaction between the particular client 14 and the color profile server. The first cookie can be referred to as the “profiler cookie.”

A second cookie may correspond to a domain name associated with the particular color image server 16, e.g., corresponding to a particular auction or photo site, from which the color image is to be downloaded. In other words, the second cookie may correspond to the particular color image server 16 at which the color profiling process was initiated. In this manner, future images delivered by that color image server 16 will be modified based on the contents of the cookies associated with the pertinent domain. The cookies will be provided by the client 14 that requested a download of the image. The second cookie can be referred to as the “image server cookie.”

The profiler cookie can be used to produce additional image server cookies for use with color image server 16 associated with other domains. Specifically, when a user situated at a client 14 accesses a color image server 16 from which the user has not previously downloaded color corrected images, the user can click on the color profiling option and be directed to color profile server 18. Upon interaction with color profile server 18, client 14 simply uploads the profiler cookie instead of repeating the color profiling process. Information concerning the domain associated with the new color image server 16 can be incorporated in the profiler cookie.

In response to receipt of the profiler cookie, color profile server 18 delivers a web page advising the user associated with client 14 of the intent to send the cookie contents to the domain indicated in the cookie, and may request user approval for, among other reasons, privacy concerns. Upon approval by the users, color profile server 18 transmits the cookie contents to the color image server 16 designated by the domain in the profiler cookie.

Color image server 16 creates an image server cookie for its own domain, and writes the cookie to client 14 for future use. Thereafter, client 14 uploads the appropriate image server cookie to the color image server 16 when requesting color corrected images for the pertinent web server 12, and can bypass interaction with color profile server 18. Client 14 uploads the appropriate image server cookie to color image server 16 when attempting to upload images.

The reliance on first and second cookies, one for color profile server 18 and the other for a particular web server 12 or color image server 16, is driven in part by existing web design considerations. In particular, cookies stored on a browser for a client typically are marked by the domain of the server that generates them, and are not generally visible to other domains. Thus, cookies created by color profile server 18 are not generally visible to color image server 16, and vice versa.

Further, cookie visibility can be further restricted by marking the cookie with a path within a server's domain. This sort of cookie will then not be visible on requests to pages outside the path, even if to the same domain. Further, a browser routinely sends all visible cookies on each request to a server. This includes not only the initial request for an HTML page, but also the requests for images to be embedded in the page. Because an image can come from a different server than the HTML page, however, the cookies sent for the HTML page can differ from those sent for the image.

In light of the above considerations, color profile server 18 acts as an intermediary not only for administration of the color profiling process, but for generation of image server cookies. This intermediary function enables color correction of all subscriber images to be performed at color image server 16 rather than at a centralized site. Also, with this intermediary function, once a client has gone through the color profiling process, he generally will not have to repeat it to obtain color correction of images for additional subscribers.

As an exception, the user may voluntarily repeat the color profiling process when local driver software or hardware such as the display device or video card associated with a client 14 has changed. Indeed, to encourage updates from time to time in order to accommodate hardware changes, expiration dates can be applied to the profiler cookie and image server cookies.

The three different servers, i.e., web server 12, color image server 16, and color profile server 18, divide the labor involved in color correction transactions. In particular, assuming the existence of a profiler cookie and an image server cookie, a web server 12 serves the HTML for the subscriber's own web pages and handles most other requests for those pages, including serving of images that are not subject to color correction. Color image server 16 serves the images that are subject to color correction.

If color image server 16 receives a color profile cookie from a client 14,, it performs color correction based on the cookie contents and the contents of the pertinent color profile cookie, and serves the color corrected image to the client. Color image server 16 also may serve an icon near the correctable color images that indicates whether the color images have indeed been corrected. If color image server 16 finds no color profile cookie, for example, it displays an icon suggesting that the user click the icon to initiate the color profiling process. Otherwise, the icon merely indicates that color correction is turned “on,” i.e., that color correction has been applied to the image.

Color profile server 18, as mentioned above, serves the pages for the color profiling process. If the color profiling process is invoked by clicking the icon displayed with a color image delivered by color image server 16, the respective client 14 probably does not have an image server cookie for the pertinent web server 12. In some cases, however, client 14 may be voluntarily repeating the color correction process to update the profile for new hardware or software. If a profiler cookie exists, then the process can be abbreviated by simply shipping the contents of the cookie to the appropriate image server domain for creation of the image server cookie.

If the profiler cookie does not exist, then the full color profiling process is served by color profile server 18. Upon completion of the color profiling process, color profile server 18 generates the profiler cookie for client 14, and passes the contents of the profiler cookie to the pertinent color image server 16. Color image server 16 then generates the image server cookie based on the profiler cookie contents and invokes the original web server URL from which the color profiling process was invoked.

The mechanisms for exchanging color correction information between the profiler cookie generated by color profile server 18 and the image server cookie generated by color image server 16 may vary. In particular, rather than delivering cookies to client 14, color profile server 18 may be arranged to transmit the color correction information to all of the color image server 16 associated with a recognized group of web servers 12.

In this manner, the color profile information obtained by color profile server 18 as a result of the color profiling process can be “broadcasted” for storage by web servers 12 or color image server 16. The advantage of this approach is that information transfer is seamless. There is no need for the user associated with a client 14 to interact with color profile server 18 following the initial color profiling process, other than to update the color profile. Rather, each web server 12 or color image server 16 stores the color correction information associated with the individual client 14, e.g., with a client ID code.

When a client 14 accesses one of the color image servers 16, the client ID code is used to retrieve the appropriate color correction information and thereby serve a color corrected image. The downside is that each web server 12 or color image server 16 may need to maintain a database of color correction information for clients 14, including clients who may never access a respective web server 12. Thus, an approach that makes use of cookies for transfer of color correction information may be more efficient and more desirable for some site administrators. Nevertheless, broadcasting of color correction information remains a viable option that may be acceptable to some site administrators, and highly convenient for end users.

The following is a description of some of the details that may be involved in passing information between web servers 12, clients 14, color image server 16, and color profile server 18 according to an indirect cookie transfer approach. This approach is indirect in the sense that the user intervenes and enters approval before the profiler cookie contents are transferred from color profile server 18 to a respective color image server 16. In delivering web pages to clients 14, web server 12 passes the URL's for correctable images stored on associated color image server 16. In addition, web servers 12 preferably incorporate color profiling icons near the images. URL's for the color profiling icons point to the pertinent color image server 16, while the hypertext link associated with the icon points to color profile server 18.

To accomplish passing of color correction information back to color image server 16, the URL of the page viewed by the user is passed to color profile server 18 when the hypertext link associated with the icon is followed by a client 14. This step of passing the URL can be accomplished either by including the URL as a parameter on the target URL, or by POSTing the information from a form that wraps the icon, i.e., with the URL stored in a hidden entry field. In the latter case, the icon serves as a button, which may require some minimal client-side scripting. In addition, as will be described, the name of web server 12 and the URL of a completion page to be served by color image server 16 after the color profiling process is complete may be included in the request to color profile server 18. Web servers can be provided with a server-side scripting function that inserts the icon code with the appropriate URLs.

For the color profiling process, color profile server 18 serves a number of web pages that can be invoked by execution of a web page provided by web server 12. In this case, the “return URL” is passed forward to each page in the sequence. The return URL can be passed as a parameter in the target URL, or by using hidden fields in forms. In some cases, the return URL can be stored as a server variable. As mentioned above, color profile server 18 handles two scenarios: (1) full color profiling when no profiler cookie exists, and (2) creation of an image server cookie when a profiler cookie already exists. In both scenarios, color profile server 18 transfers the contents of the existing or newly created profiling cookie to the pertinent color image server 16. In particular, color profile server 18 may present a button that requests permission of the user associated with a client 14 to transfer the information.

The URL for the button points to a page served by color image server 16. The request sent to color image server 16 includes both the return URL and the color information written in the profiler cookie. The request preferably is a POST request from a form, rather than a GET request with all the information set forth in the URL due to length considerations. Color profile server 18 determines the URL of the destination page at color image server 16 by reference to the return URL. Prior to transfer of the cookie contents, the user will want to know the destination.

Accordingly, color profile server 18 displays the name of the particular color image server along with the button. The name of the color image server may be associated with the web site served by web server 12. If the name of the web site is not easy to determine from the URL, it can be generated by cross-referencing the URL to a name in a database accessible by color profile server 18, or by passing the name with the return URL in the original request from the page generated by web server 12.

Upon receipt of the information from color profile server 18, the pertinent color image server 16 serves a page indicating that the color profiling process is complete. The page may be invoked by the POST request containing the color correction information and the URL of the “return” page, as received from color profile server 18. Color image server 16 writes the color correction information to the pertinent client 14 as a client cookie.

From that point forward, the image server cookie is stored by the respective client 14, and is sent to the color image server 16 associated with the pertinent web site with any request for upload or download of a color correctable image. In response to a download request, color image server 16 extracts the contents of the image server cookie from the client 14, applies a color correction to the requested image based on the contents, and delivers the color-corrected image to the client 14. In response to an upload request, color image server 16 accepts the image, extracts the contents of the image server cookie from client 14, and associates the cookie contents with the image for future use.

As an alternative approach, color correction information can be passed from color profile server 18 to a color image server 16 via a direct request, rather than being embedded in a request generated when a client 14 clicks on a button, anchor, or other input medium. This approach is direct in the sense that the user need not intervene by submitting approval for the transfer to color profile server 18. Instead, the transfer of the content of the profile cookie to the appropriate color image server 16 can be made seamless and occur in the background.

Indeed, in preferred embodiments, the user associated with client 14 may not even view pages sent by color profile server 18 for transfer of information following the initial profiling. In this manner, the transfer of color correction information from color profile server 18 to a color image server 16 happens automatically, without requiring the user associated with a client 14 to click on a link to effect the transfer. This approach makes the transfer appear more seamless to the user. The end result is the same, i.e., the transfer of color correction information contained in a profiler cookie to create an image server cookie without the need for reexecution of the color profiling process by the user.

To facilitate transfer by direct request, a client 14 can be assigned a client ID. Ordinarily, the client ID can be stored in and received from an image server cookie on the browser associated with a client 14. A client 14 that is new to the particular web site, i.e., a client that does not send an image server cookie to the particular color image server 16, will be assigned a new client ID, which is sent as a cookie with the HTML in the response from the color image server.

All URLs pointing to color profile server 18 then bear both the client ID and a web site ID as parameters, so that the color profile server can correlate requests for color correction information for the respective client 14. The URL for the color profiling icon points to color profile server 18 if there is no image server cookie. For this approach, it is preferred that the respective web server 12 and corresponding color image server 16 occupy the same domain so that they can view the same cookies.

As in the indirect approach, a color profiling icon, which appears adjacent a color correctable image or with a dialog for upload of an image, may be served from either color image server 16 or color profile server 18 in the direct transfer approach, depending on whether the color image server receives an image server cookie. If an image server cookie is present, the profiling icon is served by color image server 16 with a downloaded image, and is formulated in appearance to indicate that color correction is active, e.g., with a text message to that effect. This will be the case for most images served by color image server 16 because only new clients 16 will not have the image server cookie.

If the image server cookie is not presented, the icon is served by color profile server 18. In other words, the web page served by color image server 16 has embedded in it an icon served by color profile server 18. If a profiler cookie is present, color profile server 18 serves an icon that indicates the client 14 has already been through the color profiling process. If not, the icon indicates that the color profiling process has not previously been completed by the respective client 14. This may be represented by a colored icon to indicate that color profiling has been completed, and a black-and-white icon to indicate that it has not.

In some embodiments, the icon may indicate that the client 14 has been through the color profiling process, but that the color correction information has not yet been forwarded to the particular web site, and that the image has not been color corrected. In either case, color profile server 18 also receives the ID for the client 14 and the particular web site, which are included in the URL forwarded to color profile server 18. If the profiler cookie is present, color profile server 18 immediately forwards the client ID and the contents of the profiler cookie to the pertinent color image server 16 in a special-purpose request.

If the image server cookie is presented by a client 14, color image server 16 performs the color correction based on the information contained in the cookie. For a client 14, color image server 16 accepts the contents of the image server cookie and associates it with the uploaded image for later retrieval during color modification. If the image server cookie is not present, color image server 16 waits a short time to receive color information for this client 14 from color profile server 18. If the information is forthcoming, color image server 16 writes an image server cookie to the browser associated with the client 14. Otherwise, color image server 16 serves an uncorrected image to client 14 or, in the case of client 14, does not establish information for color correction of the uploaded image.

With this direct approach, it may be necessary for color image server 16 to keep track of color correction information forwarded by the color profile server 18 because such information may not be received synchronously with image upload and download requests from client 14, respectively. Accordingly, it may be necessary to incorporate a database application that can be shared by color image server 16 for temporary tracking of color correction information associated with individual client 14, and web server 12 for tracking and generation of client ID information. Once the information has been written to an image server cookie, the ID and color correction information for the respective client 14 can be purged from the database.

Management of ID's according to the direct transfer approach may take place as follows. The original color correction information generated by color profile server 18 can be stamped with a unique ID. The unique ID can be maintained in copies of the color correction information forwarded to color image server 16. This ID changes if the client 14 repeats the color profiling process, and can be referred to as the profiler ID. The profiler ID will remain unchanged until the next pass through the color profiling process, which may occur months later. In effect, the profiler ID corresponds to a particular color profiling sequence. The profiler ID is supplemented by the client ID and the subscriber ID. The client ID identifies a client for whom a web site is requesting color information, and the subscriber ID identifies the particular subscriber.

The client and subscriber IDs are passed via URL parameters to color profile server 18 whenever a color image server 16 has no color correction information for a particular client 14. The subscriber ID is passed back with the color correction information from color profile server 18 to color image server 16 when the color profile server determines the appropriate information for the client, based on the contents of a profiler cookie or the results of running the color profiling process. Once color image server 16 receives this information and writes it as an image server cookie to the client's browser, the subscriber ID is no longer needed.

An exemplary color profiling process will now be described in greater detail. A process as shown in FIG. 5 can be used to generate the contents of a profiler cookie as discussed above. Notably, the entire color profiling process can be completed by the user associated with a client 14 with as few as three “clicks” of a pointing device. If the user is required to click a continue button to proceed after selecting a patch, the process may take additional clicks.

If the user is permitted to proceed automatically following selection of a patch, however, the entire process can be completed in three clicks. With optional analog adjustment, separate R, G, and B blackpoints, and fine gamma steps, to be described, the process may require up to six or seven clicks. In many embodiments, the color profiling process requires no plug-ins or client side scripting when utilizing the method of selecting discrete elements, although such mechanisms can be provided in some embodiments such as in the use of slider adjustments.

The color profiling process enables visual profiling of a display device associated with a client 14 by determining accurate values of blackpoint and gamma for the R,G, and B phosphors or photodiode elements. Gamma refers to a parameter γ that indicates the rate of change in light intensity with change in digital device value. The term “blackpoint” is well known in the art and refers to the R, G, or B values lower than which there is no decrease in light emitted by the display device. Blackpoint is sometimes alternatively referred to as black onset. In accordance with the invention, three separate blackpoints are optionally determined, one for each of the R, G, and B color channels of the monitor. For use with more accurate monitors, a single dark gray RGB selection can be used to estimate a single average blackpoint value for R, G, and B.

In some display devices, such as older CRT monitors, different color channels can produce very different blackpoints. Accordingly, reliance on a single RBG blackpoint measurement in generating a color profile can introduce inaccuracies. Determination of channel-specific blackpoints, however, can reduce the degree of inaccuracy. In other words, by estimating the blackpoint for each color channel individually, a more accurate characterization of the colorimetric response of the display device can be obtained.

A more accurate colorimetric characterization enables greater accuracy in conversion of color images for delivery and display on the particular monitor. For purposes of example, alternative color profiling processes are disclosed in U.S. patent application Ser. No. 09/631,312, to Kruse et al., filed Aug. 3, 2000, and entitled “COLOR IMAGE DISPLAY ACCURACY ACROSS A GLOBAL COMPUTER NETWORK,” the entire content of which is incorporated herein by reference.

Color profile server 18 may administer a color profiling process as shown in FIG. 5 by serving a series of instructional web pages to client 14. In general, the color profiling process may involve determination of (1) blackpoint for each of the red, green, and blue (R, G, and B) color channels of the display device, (2) average gamma for R, G and B, and (3) differences in gamma for R, G, and B. Due to the wide range of differences in display device properties, determination (2) above can be subdivided into determination of (2a) a coarse gamma estimate, and (2b) a fine gamma estimate. This process is described in greater detail below with reference to FIGS. 8-14.

The color profiling process first involves determination of an estimated blackpoint for each of the color channels of the color display device, e.g., R, G, B. After determining the blackpoints, which may be merely an estimate, the color profiling process involves determination of the gamma exhibited by the display device. In particular, the process may involve determination of a coarse gamma, followed by determination of a fine gamma. Determination of the fine gamma may rely in part on the coarse gamma. In other words, the coarse gamma can be used as an initial estimate and starting point for convergence toward a more finely tuned gamma.

After determining the fine gamma, the process may involve determination of the gray balance exhibited by the display device. Gray balance provides an indication of the amount of color shift of a neutral gray toward one or more of the color channels used by the display device, e.g., red, green, and blue. The gray balance determination may rely in part on the gamma determined previously in the color profiling process and, in a particular embodiment, the fine gamma.

Next, the color profiling process involves generation of a color profile. The color profile contains information that characterizes the color response of the display device based on the blackpoints, gamma, and gray balance. The color profile then can be loaded into a cookie, or other content container, and stored locally with each client 14 for uploading to any of color image server 16 when needed.

The estimated blackpoint parameters define the dynamic range of the display device. Because the maximum RGB value always defines white, the blackpoint defines the black end point, and therefore defines the domain of values for each of the R, G, and B color channels that results in a continuous change from black to white. Again, blackpoint refers to the R, G, or B value below which there is no further decrease in light emitted by the display device.

For an individual color channel, such as R, the blackpoint is the point at which further decreases in the R value produce no further decreases in R channel light emitted by the display device. If the blackpoint for a given color channel of a display device is high, values for that channel in darker regions will be mapped to the darkest shade and shadow detail will be lost if no image correction is performed. Accordingly, obtaining an accurate blackpoint estimate is important for the accuracy of images represented by the display device.

In addition to a multi-channel blackpoint estimate, the color profile may include a gamma parameter and a gray balance parameter. The parameters together define the colorimetric response of an individual display device to enable modification of color imagery for more accurate representation on the device. The gamma parameter most affects the overall appearance of the image. Gamma determines whether an image appears overall too light or dark, or with too much contrast or too little. The third parameter, R, G, B gamma difference or “gray balance,” is important because the human eye is very sensitive to gray balance. The gray balance parameter indicates the relative balance, or imbalance, between the different color channels of a display device when producing RGB color combinations.

FIG. 8 is a flow diagram illustrating a color profiling process in greater detail. For blackpoint determination, color profile server 18 first may serve a web page for display device adjustment. The web page instructs the user to adjust the brightness and contrast of the display device. This step of display device adjustment is optional, but generally desirable in preparing the display device for blackpoint determination. Color profile server 18 may serve a web page containing several rows of dark elements such as bars, patches, characters, letters, numerals, and the like (72).

Instead of patches or bars, it may be desirable to display elements with alternative shapes such as numerals. Whereas the patches or bars may be generally rectangular, more complex shapes can be used to aid the human eye in resolving differences. Thus, numerals, letters, and other complex shapes, for example, engage the pattern recognition capabilities of the human eye and can result in heightened sensitivity to gray scale differences. When the human eye is called upon to perform pattern recognition, its sensitivity to color gradations between a given pattern and a surrounding area increase. The complex shape presents a longer boundary relative to simple shapes, and promotes an increased perimeter for contrast. Elements with complex shapes may be used in the blackpoint, coarse gamma, and fine gamma determinations to characterize the monitor.

As an alternative to rows, the elements can be arranged in columns placed side-by-side across the web page. As a further alternative, each row or column may contain, instead of several elements, only one or a small number of elements. A larger number of elements in each given row may aid the user in resolving differences between elements in adjacent rows.

The web page may instruct the user to set the brightness and contrast of the display device to maximum (74). The rows (or columns) of elements may be arranged in a series. The elements in each row preferably exhibit the same darkness or lightness. However, the elements in each row in the series differ in relative darkness or lightness relative to the elements in other adjacent rows. For example, the darkest row of elements could be situated at the bottom, with rows containing elements with progressively lighter shades being situated above in ascending order. The web page instructs the user to reduce the brightness until the darkest row of elements is barely visible (76), as shown in FIG. 8. At this point, the user may select “next” or some similar hypertext icon and proceed to the next step in the color profiling process, e.g., blackpoint determination for each of the red, blue, and green channels on an individual basis.

FIG. 9 illustrates a web page 96 for use in display device adjustment in a color profiling process as shown in FIG. 8. Rows 98 of dark elements are displayed, with the elements each row having the same gray level value, but different gray level values from elements in adjacent rows. As an example, rows 98 of dark elements (shown as numerals in the example of FIG. 9) may be presented to the user with the following gray level values: 8, 16, 24, and 32. In other words, the rows of “zeros,” “ones,” “twos,” and “threes” may have gray levels of 8, 16, 24, and 32, respectively.

As the rows of dark gray elements are displayed, the user is instructed to set brightness and contrast of the display device to maximum, using the analog or digital controls provided with the display device. The user is then further instructed to reduce the brightness of the display device until the row with the darkest (lowest gray level value) elements is barely visible, and then click “next” upon completion (100). This optional step of display device adjustment serves to prepare the monitor for the blackpoint determination carried out with respect to each color channel, as described below.

To carry out the blackpoint determination process for each color channel, several rows (or columns) of elements for each color channel may be displayed on successive web pages. Specifically, red channel, blue channel, and green channel web pages for channel-specific blackpoint determination can be served to the client in any order. In each case, the elements for a given color channel may be arranged in rows in ascending order of relative lightness or darkness, as in web page 96 of FIG. 9, which is served for display device adjustment. The rows provide a sequence of gray level gradations. The bottom row for the red channel blackpoint determination web page, for example, may be a row of “zeros” having elements bearing the darkest shade (lowest gray value) of red among the elements shown on the web page. As with web page 96, arrangement of the elements in rows or columns is for purposes of illustration. In some embodiments, display of a series of individual elements (rather than rows of elements) may suffice.

The row of darkest elements that is barely visible to the user will depend on the blackpoint for the respective channel of the display device. The rows of elements are displayed against a black, i.e., RGB=0, background. With some display devices, the user may be unable to see elements with intensity levels of 8, 16, or higher. The user is instructed to select the row of elements that is barely visible on the display device. This step determines the blackpoint, i.e., the visible “cut-off” point at which further decreases at which further decreases in the color channel value produce no further decreases in light emitted by the display device for that color channel. As an alternative, the user could be prompted to make the least visible row of elements vanish for a given color channel and then click on the remaining barely visible bar. In either case, the blackpoint can be estimated.

FIG. 10 illustrates a web page 102 for use in blackpoint determination in a color profiling process as shown in FIG. 8. Web page 102 may be substantially similar to web page 96 of FIG. 9. For example, web page 102 may include rows 104 of shaded elements. Again, display of columns of elements or a series of elements may be sufficient for some applications. As shown in FIG. 10, web page 102 instructs the user to select the row of elements that is barely visible on the display device. As in web page 96, the rows 104 in web page 102 may be arranged as rows of “zeros,” “ones,” “twos,” and “threes” having, for example, intensity levels of 8, 16, 24, and 32, respectively. Web page 102 in FIG. 10 represents the web page for red channel blackpoint determination, and includes rows of red elements set against a black background.

Upon selection of the row that is barely visible for the red channel, e.g., upon clicking on any element in the row, the user is automatically served a substantially identical web page containing rows of green elements set against a black background for purposes of determining the green channel blackpoint. Following selection of a row of green elements that is barely visible, a substantially identical web page for blue channel blackpoint determination is served to the user and the user makes a similar selection. Thus, successive web pages governing blackpoint determination for each color channel can be served automatically following selection of a row for a preceding channel. Alternatively, the user may be prompted to click on a “next” icon or similar device. Serving successive web pages automatically following selection of an element may be desirable, of course, to reduce the overall number of clicks involved in the process.

In the above manner, the user selects the row of elements that is barely visible for each color channel, and thereby provides an indication of the blackpoint for each color channel. FIG. 8 further illustrates the process. In particular, FIG. 8 shows the display of rows of dark red elements or characters (78), and selection of the row that is barely visible (80), and further illustrates the computation of the estimated blackpoint for the red channel based on the selected row (82). Alternatively, the estimated blackpoint can be computed later based on the selected row.

Similarly, for the green channel, a row of dark green characters is displayed (84), followed by selection of the row that is barely visible (86), and computation of an estimated blackpoint for the green channel based on the selected row (88). Finally, for the blue channel, a row of dark blue characters is displayed (90), followed by selection of the row that is barely visible (92), and computation of an estimated blackpoint for the blue channel based on the selected row (94).

Following selection of the barely visible row of elements displayed on each successive web page, the pertinent client 14 transmits the result to color profile server 18. Alternatively, the results for all color channels can be transmitted at the same time following completion of the blackpoint determination for the last color channel. Color profile server 18 then may compute the estimated blackpoint for each channel or simply store the parameters for later computation, e.g., by color imager server 18.

The complete description of the display device behavior can be represented by the following equation which relates RGB to XYZ:

$$[ \begin{matrix}X \\ Y \\ Z\end{matrix} ] = [ \begin{matrix}{X}_{r , max} & {X}_{g , max} & {X}_{b , max} \\ {Y}_{r , max} & {Y}_{g , max} & {Y}_{b , max} \\ {Z}_{r , max} & {Z}_{g , max} & {Z}_{b , max}\end{matrix} ] [ \begin{matrix}R \\ G \\ B\end{matrix} ]$$

$$where$$

$$R = \{ \begin{matrix}{[ ( {d}_{r} - {k}_{o , r} ) / ( 1.0 - {k}_{o , r} ) ]}^{{y}_{r}} \\ 0 \end{matrix} , \begin{matrix}[ ( {d}_{r} - {k}_{o , r} ) / ( 1.0 - {k}_{o , r} ) ] \geq 0 \\ [ ( {d}_{r} - {k}_{o , r} ) / ( 1.0 - {k}_{o , r} ) ] < 0\end{matrix} \}$$

$$G = \{ \begin{matrix}{[ ( {d}_{g} - {k}_{o , g} ) / ( 1.0 - {k}_{o , g} ) ]}^{{y}_{g}} \\ 0 \end{matrix} , \begin{matrix}[ ( {d}_{g} - {k}_{o , g} ) / ( 1.0 - {k}_{o , g} ) ] \geq 0 \\ [ ( {d}_{g} - {k}_{o , g} ) / ( 1.0 - {k}_{o , g} ) ] < 0\end{matrix} \}$$

$$B = \{ \begin{matrix}{[ ( {d}_{b} - {k}_{o , b} ) / ( 1.0 - {k}_{o , b} ) ]}^{{y}_{b}} \\ 0 \end{matrix} , \begin{matrix}[ ( {d}_{b} - {k}_{o , b} ) / ( 1.0 - {k}_{o , b} ) ] \geq 0 \\ [ ( {d}_{b} - {k}_{o , b} ) / ( 1.0 - {k}_{o , b} ) ] < 0\end{matrix} \}$$

The variables dᵣ, d_{g}, and d_{b} are the digital input values for the red, green, and blue channels normalized to 1.0. The parameters k_{0,r}, k_{0,g}, and k_{0,b}, are the blackpoints and the parameters γᵣ, γ_{g}, and γ_{b} are the gammas for the red, green, blue channels.

The values of parameters k_{0,r}, k_{0,g}, and k_{0,b}, are determined as follows: Assume that (regardless of the properties of a particular monitor) for the red channel there exists a minimal visible set of values for XYZ that can be detected by the human eye, designated as the vector (X_{t,r}, Y_{t,r}, Z_{t,r}). This vector will have a unique corresponding value for R in the expression above, designated as Rₜ. For a particular monitor with specific values of γᵣ and k_{0,r} there will be a unique device value associated with Rₜ which is designated by d_{t,r}:

$${R}_{t} = \{ \begin{matrix}{[ ( {d}_{i , r} - {k}_{o , r} ) / ( 1.0 - {k}_{o , r} ) ]}^{{y}_{r}} \\ 0 \end{matrix} , \begin{matrix}[ ( {d}_{t , r} - {k}_{o , r} ) / ( 1.0 - {k}_{o , r} ) ] \geq 0 \\ [ ( {d}_{t , r} - {k}_{o , r} ) / ( 1.0 - {k}_{o , r} ) ] < 0\end{matrix} \}$$

This device value d_{t,r} is determined by the user during the color profiling procedure as described, i.e., by selecting the darkest barely visible row of elements in the blackpoint determination web page for red. The value of Rₜ is empirically determined. For example, for a calibrated display system in a dark room with k_{0,r}=0.0 and γᵣ=2.2, a red patch may be visible for d_{t,r}=8/255 gray levels which implies Rₜ=(8/255)^{2.2}.

The exact value of k_{0,r} can be calculated by solving two simultaneous equations, namely the equation above for Rₜ and the equation for R_{0.33} which will be described below. Alternatively, a reasonable estimate can be made for k_{0,r} by assuming a gamma of 2.2. If this assumption is made, the value of k_{0,r} can be estimated as:

$${R}_{t} = {( \frac{8.0}{255.0} )}^{22} = {[ ( {d}_{t , r} - {k}_{o , r} ) / ( 1.0 - {k}_{o , r} ) ]}^{22}$$

$$( \frac{8.0}{255.0} ) = [ ( {d}_{t , r} - {k}_{o , r} ) / ( 1.0 - {k}_{o , r} ) ] \approx {d}_{t , r} - {k}_{o , r}$$

$${k}_{o , r} = {d}_{t , r} - ( \frac{8.0}{255.0} )$$

In a similar fashion, the values for k_{0,g} and k_{0,b}, can be determined.

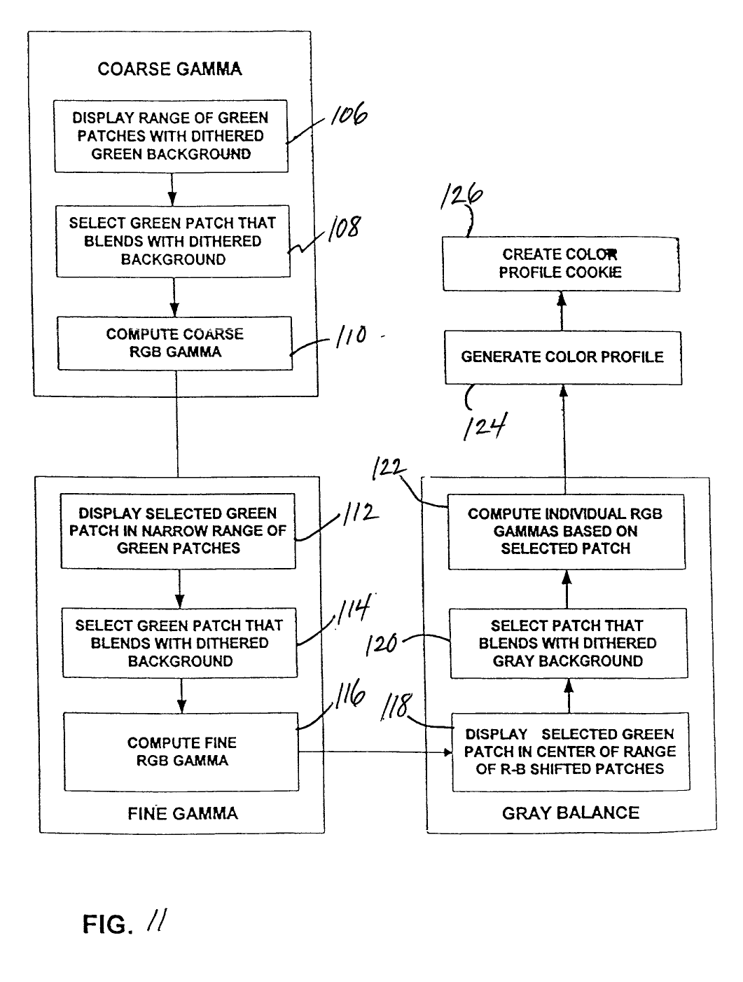

FIG. 11 is a flow diagram illustrating gamma and gray balance determination in a color profiling process. For determination of coarse gamma, one of the web pages served by color profile server 18 displays a range of green elements, e.g., patches, against a dithered green background (106). The coarse gamma determination web page can be served immediately and automatically following selection of a row of elements in the last blackpoint determination web page, or in response to selection of a “next” icon or similar device.

In one embodiment, the coarse gamma determination is limited to only the green color channel. Specifically, the coarse gamma determination is made using a series of green elements against a green dithered background. Green is the most dominant and intense phosphor among red, green, and blue, and is highest in contrast. Green also has the highest L*. Note also that green most closely matches the photopic V(λ) response of the eye. This approach to coarse gamma determination considers only the green color channel, and essentially ignores red and blue.

In this manner, the coarse gamma measurement concentrates on the most dominant color channel and avoids errors that can arise due to the red-blue imbalances that are highly prevalent in many display devices. Thus, the elements displayed for the coarse gamma determination may be green patches with different darkness or lightness values. Alternatively, a combined coarse gamma for all of the color channels may be determined as described in the above-referenced U.S. patent application Ser. No. 09/631,312.

Upon display of the green patches, the user is instructed to select a patch that appears to most closely blend with the dithered background (108). The green patch “blends” with the dithered background in the sense that it appears to closely match the level of the background. An example of a range of green patches displayed against a green dithered background is shown in FIG. 12 and indicated by reference numeral 128. This range of green patches and the green dithered background can be displayed in a web page served by color profile server 18.

Based on the selected green patch, which again may be selected by clicking on it with a pointing device, color profile server 18 computes a coarse gamma (110). The coarse gamma determined in this step can be used as an estimate for the average gamma of R, G, and B via selection of a green patch from the set of green patches against the dithered green background. The dithered green background may be set at approximately 25% to 50%. Dithered backgrounds approaching approximately 33% may more closely match the actual midpoint of black to green transition for the display device, and may be preferred for typical display devices.

By alternating black and green at an appropriate frequency, a 25%, 33%, or 50% green background can be produced. For a CRT, turning on or off all of the pixels in a given horizontal line should produce more predictable output from display device to display device than modulating individual pixels to form vertical lines, due to the video bandwidth of the device. For flat panel devices, this is less of an issue. To accommodate clients using both CRT's and flat panel devices, however, generation of the dithered background by use of alternating horizontal lines is preferred.

The center patch in the range 128 of patches can be based on an average gamma of 2.0, since most monitors range from 1.6 to 2.5. The other green patches that surround the center patch may proceed in a sequence with relatively large steps, e.g., 8 gray levels apart from one another. Coarse gamma can be estimated using the equation:

G_{0.33}=0.333=[(d_{0.33,g}−k_{0.g})/(1.0−k_{0.g})]^{γ}^{_{g}}

where d_{0.33,g} is the gray level value (normalized to 1.0) of the selected patch that appears to most closely blend in with the background, k_{0,g} is the previously determined blackpoint, G_{0.33} is the relative intensity of the green channel (equal to ⅓) , and γ_{g} is the green gamma. As an alternative to actually computing the coarse gamma, the green level value of the selected patch simply is carried forward for use in the fine gamma process. In this case, the value can eventually be discarded.

After the coarse gamma estimate is obtained, fine gamma is estimated. Fine gamma is a refined or “fine-tuned” estimate for the average gamma of R, G, and B. Fine gamma can be determined by selection of another green patch from a set of green patches presented against a dithered green background. In this case, the center patch may be identical to the green patch selected by the user for determination of coarse gamma. Thus, the coarse gamma step “informs” the fine gamma step. In effect, the selected coarse gamma patch may serve as a starting point for the fine gamma determination. Specifically, the green patch selected in the coarse gamma determination can be used as the central patch for the fine gamma determination.

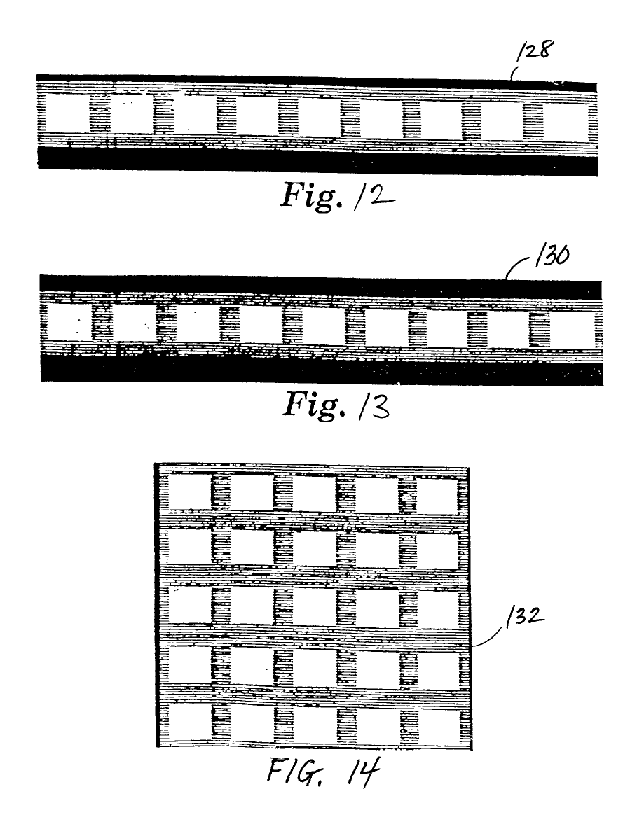

A range of patches for determining fine gamma is illustrated in FIG. 13 and designated by reference numeral 130. The patches in this range are in a sequence with smaller steps centered about the center green patch selected in the coarse gamma process. For example, the patches may be set at 4 green levels apart, in contrast to the 8 green levels used as the difference for the coarse gamma determination. In this manner, a narrower range is used to “fine-tune” the coarse gamma estimate, with the center of the range having been “learned” from the coarse gamma estimate.

With further reference to FIG. 11, a web page served by color profile server 18 displays the selected green patch from the coarse gamma estimate among a narrower range of green patches (112). The user then is instructed to select the green patch that most closely blends with the same dithered green background as used for coarse gamma (114). Based on the selected patch, color profile server 18 computes a single fine RGB gamma (116). Thus, the fine gamma is the overall gamma estimated for the RGB channels. Alternatively, as mentioned above, the RGB value of the selected patch can simply be stored for use by color image server 16 in computing fine gamma and rendering color corrections. In any event, a refined estimate for gamma can be computed according to the equation:

G_{0.33}=0.333=[(d_{0.33,g}−k_{0.g})/(1.0−k_{0.g})]^{γ}^{_{g}}

where d_{0.33,g} is the green level value (normalized to 1.0) of the selected patch that blends in with the background, k_{0,g} is the previously determined blackpoint, G_{0.33} is the relative intensity of the green channel (equal to ⅓), and γ_{g} is the green gamma.

To determine gray balance, color profile server 18 serves a web page that displays a plurality of RGB patches. The RGB patches can be generated with the same value of green selected in the previous fine gamma step in conjunction with values of red and blue that are substantially equal to or systematically shifted from the previously selected value of green. The RGB patches can be displayed against a gray background which is dithered in the same manner as the green dithered background of the previous step (fine gamma) (118). Again, this step “learns” from the previous one, and forms part of a cascading series of color profiling steps (coarse gamma, fine gamma, and gray balance) that help narrow the search for the correct gamma. The user is then instructed to select the gray patch that appears to most closely blend with the dithered background (120). Based on the selected gray patch, individual RGB gammas are computed (122). Notably, the overall gray balance determination can be made with a single click of the user's pointing device.

Thus, in this gray balance process, the green intensity value selected in the fine gamma process is used to generate the gray patches that exhibit +/− (plus/minus) differences or “shifts” in red and blue about the value of the gray patch. For example, the value of green selected in the fine gamma process can be displayed in the center of the range in conjunction with substantially identical values of red and blue. The gammas for red and blue are then fine tuned by the gray balance determination, which helps identify red-blue imbalance in the display device. Thus, the green gamma is “locked in” in the gray balance step, while the red and blue imbalance is determined. In other words, every patch in the gray balance array carries the same green value, but is modulated by different gradations of red and blue. This step eliminates one axis of variation, green, but permits identification of any imbalance between red and green or blue and green. This limits the range of choices to a more finely-tuned area, and aids the user in making a more accurate selection.

The range of patches for the gray balance determination may be a two-dimensional array of patches with red-blue-shifted patches arranged around a central gray patch with red, green, and blue value determined according to the gamma estimate from the fine gamma process. In other embodiments, the red channel could be used to determine the initial RGB gamma estimate, followed by a gray balance determination that resolves imbalance between green and red or blue and red.

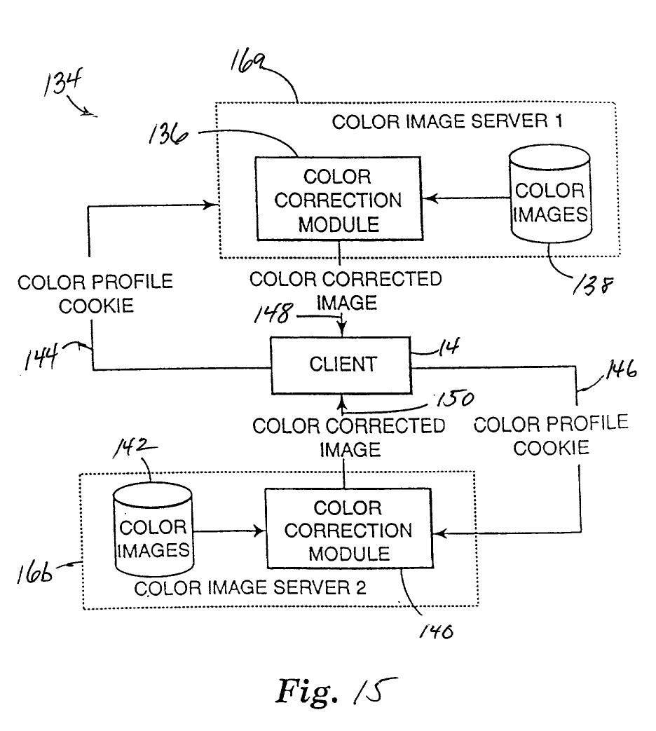

FIG. 14 illustrates an example of a two-dimensional range 132 of gray patches arranged in a five-by-five matrix for use in the gray balance determination. Each patch represents a shift away from the central gray patch along either the blue axis, the red axis, or a combination of both, but preferably does not represent any further green shift. The user selects the patch that appears to most closely blend with the dithered gray background, which may be a 33% dithered background. The central patch can optionally be highlighted to indicate it is the preferred default choice.

The number of patches and the exact values of RGB for each patch can be quite flexible. For example, in the case of the image in FIG. 14, all patches can be selected to have identical values of L* as indicated by the estimated profile for the display based on phosphors, average gamma, and blackpoint. Patches adjacent to the center may differ by all permutations of +/−3 ΔE for a* and for b* as estimated from a Matrix TRC (tone reproduction curve) profile constructed from the above parameters.

Patches around the outer perimeter of the grid array may differ from the center by +/−6 ΔE in R and B. Alternatively, for simplicity, one can elect to vary R and B only by +/−a fixed amount such as +/−5 gray levels and +/−10 gray levels. Preferably, all patches are relatively small deviations from the central patch in all directions of color space of approximately constant L*. This test will help determine in a sensitive manner whether there exists a significant difference in the gammas of R, G, and B, and thereby expose significant gray imbalance between R and B.

The two-dimensional format of the patches shown in FIG. 14 may aid the user's selection of the correct patch. The patch from the previous step in the color profiling process, i.e., fine gamma, is placed at the center in this embodiment. Adjacent patches differ in gray level as the array extends outward such that the outer periphery of the array contains patches that are two gradations removed from the central patch. The array produces a visual “funnel” effect that, from experience, tends to direct the user toward the central patch as the starting point for matching with the background. The differences between patches in the two-dimensional array are more clear and dramatic than in a one-dimensional strip of patches. As the array extends outward, the shift becomes greater. Thus, the gradations are well pronounced and aid the user in picking the appropriate patch which, in many cases, will be the central patch selected in the previous step of the color profiling process.

If the user selects the central patch, a single gamma value is used for the R, G, and B channels. If one of the other patches are selected, three separate gammas are calculated based on the equations:

R_{0.33}=0.333=[(d_{0.33,r}−k_{0,r})/(1.0−k_{0,r})]^{γ}^{ᵣ}

B_{0.33}=0.333=[(d_{0.33,b}−k_{0,b})/(1.0−k_{0,b})]^{γ}^{_{b}}

where the subscripts for γ and d_{0.33} indicate unique values for the R and B channels. The values for d_{0.33} for each channel are given by the values of RGB of the particular patch selected in this gray balance step. These equations are combined with a set of phosphor values to generate accurate profiles for the client's display device, using equations well known in the art, and referred to as Matrix TRC formalism in the International Color Consortium (ICC) specification. Again, calculations can be performed by color profile server 18 or by a color correction module associated with color image server 16.

The process of selecting patches in the coarse gamma, fine gamma, and gray balance determination steps is advantageous because, in preferred embodiments, it requires no applications, applets, or other client-side scripts to be loaded at the client side. Rather, the user may simply select one of the patches displayed in a web page. In other embodiments, however, if applications, applets, or client-side scripts are used, it is conceivable that smooth slider bars, +/− arrows, and the like could be used to adjust the color of a single patch in real-time for comparison to the dithered background. In this manner, the user has the ability to precisely match a single patch to the background, rather than select from a finite set of patches the one that most closely matches. This technique of real-time adjustment also may be useful for non-networked approaches to color calibration and characterization. In this case, for blackpoints, gamma, and/or gray balance, the patch or element selected by the user may be a single adjustable patch in a condition in which the slider or other adjustment medium has adjusted its color to a level that is visually acceptable to the user, i.e., to a point at which the patch appears to match the dithered background.

With further reference to FIG. 11, based on the blackpoint, coarse gamma, fine gamma, and gray balance processes, a color profile for the display device is generated (124). Upon generation of the color profile, a color profiler cookie is created (126). Information representative of the color profile is added to the color profiler cookie for future use. In particular, the information can be used to create an image server cookie for future interaction between the particular client 14 and the particular web server 12 and color image server 16. Although the color profile is especially useful for characterizing display devices in a network, it also may be useful in a non-networked application. In particular, the color profiling process described herein may find ready use in the calibration and characterization of an individual display device for correction of content generated or obtained locally with the device, rather than across a network.

Advantageously, there is no need for the client 14 to provide information regarding the configuration of its display device. Very satisfactory results can occur using an average set of phosphor values based on published standards such as sRGB, Apple Macintosh RGB, and the like. If desired, further steps can be added, particularly in order to address the issue of phosphor values and white point. The color profiling process simply results in generation of a cookie that serves as a container and vehicle for passing information characterizing the color response of the display device associated with client 14 to color image server 16. Alternatively, the chromaticity information and white point can in some cases be obtained from the display utilizing communication protocols such as VESA and/or from the operating system of the computer. The usefulness of this invention will continue because, with current technology, the RGB blackpoints and gammas are difficult to maintain perfectly at the hardware level even with expensive electronic circuitry.

Ordinarily, all cookies visible to a particular domain are attached to each request from a browser application executed by a client 14. For this reason, a typical browser limits each domain to a maximum of twenty cookies. To avoid consuming the allotment of cookies for a particular web site, all of the color correction information for a particular client 14 preferably is packed into a single profiler cookie and a single image server cookie. For example, a number of items can be packed into the value string of the image server cookie or the profiler cookie, as the case may be. In particular, each cookie should include the gamma values for R, G, and B. Each gamma value may be a value between 1.0 and about 3.0. In addition, the cookie may include the chromaticity values for black and white, e.g., expressed as a value between 0 and +1000.0.

An exemplary cookie may have the following items packed into its value string, each demarcated by a separator:

(1) Cookie format version code—a numeric code, e.g., 1 to 3 bytes, plus separator.

(2) Cookie installation date—the usual cookie-style timestamp (milliseconds after midnight of Jan. 1, 1970, GMT), e.g., 12 to 13 bytes, plus separator.

(3) Unique profiler ID assigned to this color information when it is generated by the color correction sequence; a long integer, e.g., 4 bytes, plus separator (but possibly longer).

(4) Gamma and blackpoint values for R, G, B—each a text representation of a floating-point value between 1.0 and about 3.0, retaining 4 decimal digits. The decimal point could be implied. Thus, the gamma values may take up 5 or 6 bytes plus a separator each, or three times that overall. Alternatively, the selected tint values chosen for R, G, and B can be indicated, enabling the gamma and blackpoint values to be calculated at a later time by a server upon upload of the cookie.

(5) Chromaticity for Black and White—each a text representation of a floating-point value between 0 and +1000.0, retaining 4 significant digits. Thus, this may take up 6 or 7 bytes plus a separator each, or two times that overall.

(6) Number of bits per color—two decimal digits: two bytes plus separator.

(7) Display Device ID code—an alphanumeric code, which may be roughly 10 bytes plus separator.

(8) Cookie Data Checksum—a long integer: 4 bytes.

The example cookie described above has about 68 bytes plus 10 separators. The separator character should be chosen so that the string does not have to be “escaped”; the caret (ˆ ) is frequently used this way. Thus, the typical size for the value string may be about 80 bytes.

FIG. 15 is block diagram illustrating transmission of color correction information in a system as shown in FIGS. 1 and 2. In particular, FIG. 15 illustrates a system 134 in which image server cookies have already been created for two different color image server 16a, 16b accessed by an individual client 14. In this case, upon accessing a web page from a web server 12, client 14 requests images from color image server 16a. When requesting images from another web server 12, client 14 requests images from color image server 16b. Color image server 16a incorporates both a color correction module 136 and an archive 138 of color images. Similarly, color image server 16b includes a color correction module 140 and an archive 142 of color images.

When client 14 sends an image request to color image server 16a, it sends along a color profile cookie, i.e., an image server cookie, as indicated by line 144. Likewise, as indicated by line 146, client 14 sends an image server cookie to color image server 16b when requesting an image. In each case, the image server cookie contains a color profile that provides color correction information for use by the respective color correction module 136, 138 in modifying, i.e., color correcting, the color images served from image archives 138, 142, respectively. Thus, when a request is received, color images server 16a or 16b processes the accompanying image server cookie to extract the contents, and controls the respective color correction module 136, 140 based on the extracted contents. In this manner, client 14 receives color corrected images, as indicated by reference numerals 148, 150.

The manner in which color correction modules make use of the color profiles contained in the image server cookies will now be described. In the embodiment described with reference to FIGS. 8-14, blackpoints for each color channel are estimated based on red, green, and blue elements selected by a user associated with a respective client 14. Thus, the output of the color profiling process is a blackpoint RGB value and a gamma, or individual RGB gammas. Now we assume that these values have been determined in the manner described above. The complete description of the display device behavior can be given by the following equation which relates RGB ->XYZ:

$$[ \begin{matrix}X \\ Y \\ Z\end{matrix} ] = [ \begin{matrix}{X}_{r , max} & {X}_{g , max} & {X}_{b , max} \\ {Y}_{r , max} & {Y}_{g , max} & {Y}_{b , max} \\ {Z}_{r , max} & {Z}_{g , max} & {Z}_{b , max}\end{matrix} ] [ \begin{matrix}R \\ G \\ B\end{matrix} ]$$

$$where$$

$$R = \{ \begin{matrix}{[ ( {d}_{r} - {k}_{o , r} ) / ( 1.0 - {k}_{o , r} ) ]}^{{y}_{r}} \\ 0 \end{matrix} , \begin{matrix}[ ( {d}_{r} - {k}_{o , r} ) / ( 1.0 - {k}_{o , r} ) ] \geq 0 \\ [ ( {d}_{r} - {k}_{o , r} ) / ( 1.0 - {k}_{o , r} ) ] < 0\end{matrix} \}$$

$$G = \{ \begin{matrix}{[ ( {d}_{g} - {k}_{o , g} ) / ( 1.0 - {k}_{o , g} ) ]}^{{y}_{g}} \\ 0 \end{matrix} , \begin{matrix}[ ( {d}_{g} - {k}_{o , g} ) / ( 1.0 - {k}_{o , g} ) ] \geq 0 \\ [ ( {d}_{g} - {k}_{o , g} ) / ( 1.0 - {k}_{o , g} ) ] < 0\end{matrix} \}$$

$$B = \{ \begin{matrix}{[ ( {d}_{b} - {k}_{o , b} ) / ( 1.0 - {k}_{o , b} ) ]}^{{y}_{b}} \\ 0 \end{matrix} , \begin{matrix}[ ( {d}_{b} - {k}_{o , b} ) / ( 1.0 - {k}_{o , b} ) ] \geq 0 \\ [ ( {d}_{b} - {k}_{o , b} ) / ( 1.0 - {k}_{o , b} ) ] < 0\end{matrix} \}$$

The variables dᵣ, d_{g}, and d_{b} are the digital input values normalized to 1.0. The parameters k_{0,r}, k_{0,g}, and k_{0,b}, are the blackpoints for the red, green, and blue channels, and the parameters γᵣ, γ_{g}, and γ_{b} are the gammas for the red, green, blue channels. Thus, the gamma and blackpoint information contained in the image server cookie for a respective display device can be used in the above equations to produce, in effect, a color profile. The color profile can be used to perform a transformation of the image data sufficient to produce calibrated output on the display device.

The above approach is different than other attempts to characterize display devices such as equation 21 in Berns, “CRT Colorimetry. Part I: Theory and Practice.” In most characterizations, the “k” parameters are used to describe black offset rather than blackpoint. Black offset refers to the non-zero intensity measured or perceived from a display for RGB=0. In our experience, the contrast/brightness adjustment procedure used in a color profiling process in accordance with embodiments of this invention minimizes the effect of this phenomenon. However, non-zero blackpoints are very possible even after the contrast/brightness adjustment, and therefore should be taken into account.

This profile description can either be used in this format or converted to formats such as those specified by the ICC. This format is also known as the Matrix TRC format, and utilizes a generic lookup table for the expressions above for R, G, and B rather than an equation combined with a matrix similar to above. The above information, e.g., gammas, blackpoints, and the like, can be stored in a cookie on a computer associated with a client 14. Alternatively, the individual data which are the RGB values of the patches selected by the user can be stored in the cookie, which can permit improved profile technology to be employed at a later date utilizing the same input information.

To implement a system as described herein with an existing archive of images and HTML codebase for a web site, the existing web server 12 is modified to replace existing image file references indicated in HTML pages with similar references to a pertinent color image server 16 equipped with a color correction module. For example, an existing subscriber image file reference called:

http://SubscriberName.com/images/ImageName jpg

could be replaced with:

http://correction.SubscriberName.com/images/ImageName jpg.

These modified references in the HTML page then issue a command to the color image server 16 to serve the requested image. When the color image server 16 receives the command, it also receives the image server cookie, if one exists, and applies the information contained in the cookie to perform color correction. The color image server 16 then reads the pertinent image file, creates a unique display profile utilizing the display parameters stored in the image server cookie, and converts the image from before sending it to the client's browser.

All images stored on the web server 12 may have a corresponding copy file of the same name residing on the subscriber color image server 16. The color image server 16 may access this database of image files to read, convert, and send images referenced by the HTML page sent to the client 14. According to one embodiment, color image server 16 may use a very simple and quick technique for color management. In particular, all images on the color image server 16 preferably have a predetermined RGB color space. This typically means that original images are converted from the color space of corresponding devices, e.g., such as scanners, digital cameras, and the like, to the standard color space determined by a particular web site. Good examples of standard RGB color spaces are ColorMatch RGB, which has a color temperature for the “virtual display” of D50. Other color spaces such as Adobe RGB have an excellent gamut, but have a color temperature of D65. When an image on an HTML page sent to the client 14 is referenced via the color image server 16 associated with a web server 12 such as:

correction.SubscriberName.com/images/ImageNamejpg

color image server 16 accesses the corresponding image and converts the RGB data in real time before sending the image to the client destination. The conversion can be performed according to the following calculation:

$${R}_{s} = \{ \begin{matrix}{[ ( {d}_{r , s} - {k}_{o , r , s} ) / ( 1.0 - {k}_{o , r , s} ) ]}^{{y}_{r , s}} \\ 0 \end{matrix} , \begin{matrix}[ ( {d}_{r , s} - {k}_{o , r , s} ) / ( 1.0 - {k}_{o , r , s} ) ] \geq 0 \\ [ ( {d}_{r , s} - {k}_{o , r , s} ) / ( 1.0 - {k}_{o , r , s} ) ] < 0\end{matrix} \}$$

$${G}_{s} = \{ \begin{matrix}{[ ( {d}_{g , s} - {k}_{o , g , s} ) / ( 1.0 - {k}_{o , g , s} ) ]}^{{y}_{g , s}} \\ 0 \end{matrix} , \begin{matrix}[ ( {d}_{g , s} - {k}_{o , g , s} ) / ( 1.0 - {k}_{o , g , s} ) ] \geq 0 \\ [ ( {d}_{g , s} - {k}_{o , g , s} ) / ( 1.0 - {k}_{o , g , s} ) ] < 0\end{matrix} \}$$

$${B}_{s} = \{ \begin{matrix}{[ ( {d}_{b , s} - {k}_{o , b , s} ) / ( 1.0 - {k}_{o , b , s} ) ]}^{{y}_{b , s}} \\ 0 \end{matrix} , \begin{matrix}[ ( {d}_{b , s} - {k}_{o , b , s} ) / ( 1.0 - {k}_{o , b , s} ) ] \geq 0 \\ [ ( {d}_{b , s} - {k}_{o , b , s} ) / ( 1.0 - {k}_{o , b , s} ) ] < 0\end{matrix} \} \\ [ \begin{matrix}{R}_{c} \\ {G}_{c} \\ {B}_{c}\end{matrix} ] = {[ \begin{matrix}{X}_{r , c , max} & {X}_{g , c , max} & {X}_{b , c , max} \\ {Y}_{r , c , max} & {Y}_{g , c , max} & {Y}_{b , c , max} \\ {Z}_{r , c , max} & {Z}_{g , c , max} & {Z}_{b , c , max}\end{matrix} ]}^{- 1} [ \begin{matrix}{X}_{r , s , max} & {X}_{g , s , max} & {X}_{b , s , max} \\ {Y}_{r , s , max} & {Y}_{g , s , max} & {Y}_{b , s , max} \\ {Z}_{r , s , max} & {Z}_{g , s , max} & {Z}_{b , s , max}\end{matrix} ] [ \begin{matrix}{R}_{s} \\ {G}_{s} \\ {B}_{s}\end{matrix} ]$$

$${d}_{r , c} = {k}_{o , r , c} + ( 1.0 - {k}_{o , r , c} ) {min ( 1.0 , {R}_{c} )}^{1 / {γ}_{r , c}}$$

$${d}_{g , c} = {k}_{o , g , c} + ( 1.0 - {k}_{o , g , c} ) {min ( 1.0 , {G}_{c} )}^{1 / {γ}_{g , c}}$$

$${d}_{b , c} = {k}_{o , b , c} + ( 1.0 - {k}_{o , b , c} ) {min ( 1.0 , {B}_{c} )}^{1 / {γ}_{b , c}}$$

Note that the matrices above can be concatenated into a single matrix for increased processing speed.

As an alternative architecture, all images for various web sites may be stored at a central color image server 16. Color profile server 18 may reside or be integrated with color image server 16 in such an embodiment. In this case, color profiling server 18 provides web pages for guidance of a color profiling process as described herein. Color image server 16 or color profile server 18 may include a database server for storage of individual color profiles associated with client 14. When a client 14 requests an image tagged in the code sent by one of web servers 12, it is directed to the central color image server 16. The color image server 16 may use a client ID sent from the client to retrieve the appropriate color profile and apply it to modify the requested color image using techniques as described herein for color correction. In this manner, color image server 16 provides color corrected images without the need for transfer of cookies and the like between client 14 and the color image server.

A number of embodiments of the present invention have been described. Nevertheless, it will be understood that various modifications may be made without departing from the spirit and scope of the invention. Accordingly, other embodiments are within the scope of the following claims.

1. A method comprising:
identifying a technician responsible for adjustment of color characteristics of an image; and
permitting an upload of the image to a web server if the technician satisfies a qualification criterion.

2. The method of claim 1, wherein the qualification criterion includes a minimum level of color adjustment skill.

3. The method of claim 1, wherein the qualification criterion includes a minimum level of care in adjusting color characteristics of the image.

4. The method of claim 1, further comprising assigning the technician an upload password that permits the upload of the image if the technician satisfies the color adjustment skill criterion.

5. The method of claim 1, further comprising creating an image file representative of the image, and including in the image file an indication of the identity of the technician.

6. The method of claim 1, further comprising creating metadata for an image file representative of the image, the metadata including an indication of the identity of the technician.

7. The method of claim 1, wherein the technician adjusts and uploads a plurality of images, the method further comprising auditing the images uploaded by the technician to assess quality of the adjustments.

8. The method of claim 1, further comprising:
qualifying the technician for upload of the image if the technician satisfies the color adjustment skill criterion;
creating an image file representative of the image;
including in the image file an indication of the identity of the technician;
identifying the technician by reference to the indication;
auditing the image to assess quality of the adjustments made by the technician; and
revoking the qualification from the technician in the event the assessed quality is unacceptable.

9. The method of claim 1, further comprising:
qualifying the technician for upload of the image if the technician satisfies the color adjustment skill criterion;
auditing the image to assess quality of the adjustments made by the technician; and
revoking the qualification from the technician in the event the assessed quality is unacceptable.

10. The method of claim 1, further comprising adjusting the color characteristics of the image to more closely approximate the appearance of a physical item.

11. The method of claim 10, wherein the physical item is a retail item offered for sale via the web server.

12. The method of claim 10, further comprising:
making further adjustments to the color characteristics of the image based on color response characteristics of a display device associated with a client; and
downloading the adjusted image from the web server to the client via a computer network.

13. The method of claim 12, further comprising guiding the client through a color profiling process via one or more web pages to estimate the color response characteristics of the display device.

14. A computer-readable medium containing instructions that cause a programmable processor to:
identify a technician responsible for adjustment of color characteristics of an image; and
permit an upload of the image to a web server if the technician satisfies a color adjustment skill criterion.

15. The computer-readable medium of claim 14, wherein the qualification criterion includes a minimum level of color adjustment skill.

16. The computer-readable medium of claim 14, wherein the qualification criterion includes a minimum level of care in adjusting color characteristics of the image.

17. The computer-readable medium of claim 14, wherein the instructions cause the processor to assign the technician an upload password that permits the upload of the image if the technician satisfies the color adjustment skill criterion.

18. The computer-readable medium of claim 14, wherein the instructions cause the processor to create an image file representative of the image, and include in the image file an indication of the identity of the technician.

19. The computer-readable medium of claim 14, wherein the instructions cause the processor to create an image file representative of the image, and create metadata for the image file, the metadata including an indication of the identity of the technician.

20. The computer-readable medium of claim 14, wherein the technician adjusts and uploads a plurality of images, and the instructions cause the processor to audit the images uploaded by the technician to assess quality of the adjustments.

21. The computer-readable medium of claim 14, wherein the instructions cause the processor to:
qualify the technician for upload of the image if the technician satisfies the color adjustment skill criterion;
create an image file representative of the image;
include in the image file an indication of the identity of the technician;
identify the technician by reference to the indication;
audit the image to assess quality of the adjustments made by the technician; and
revoke the qualification from the technician in the event the assessed quality is unacceptable.

22. The computer-readable medium of claim 14, wherein the instructions cause the processor to:
qualify the technician for upload of the image if the technician satisfies the color adjustment skill criterion;
audit the image to assess quality of the adjustments made by the technician; and
revoke the qualification from the technician in the event the assessed quality is unacceptable.

23. The computer-readable medium of claim 14, wherein the instructions cause the processor to adjust the color characteristics of the image to more closely approximate the appearance of a physical item.

24. The computer-readable medium of claim 23, wherein the physical item is a retail item offered for sale via the web server.

25. The computer-readable medium of claim 24, wherein the instructions cause the processor to:
make further adjustments to the color characteristics of the image based on color response characteristics of a display device associated with a client; and
download the adjusted image from the web server to the client via a computer network.

26. The computer-readable medium of claim 24, wherein the instructions cause the processor to guide the client through a color profiling process via one or more web pages to estimate the color response characteristics of the display device.
